(19) United States
(12) Patent Application Publication
(10) Pub. No.: US 2026/0145720 A1
(43) Pub. Date: May 28, 2026

(54) CART APPLICABLE TO A STORAGE BOX

(71) Applicant: Nanjing Chervon Industry Co., Ltd., Nanjing (CN)

(72) Inventors: Cheng Chen, Nanjing (CN); Changning Zhang, Nanjing (CN)

(21) Appl. No.: 19/401,822

(22) Filed: Nov. 26, 2025

Related U.S. Application Data
(63) Continuation-in-part of application No. PCT/CN2024/118109, filed on Sep. 11, 2024.
(63) Continuation-in-part of application No. PCT/CN2024/100720, filed on Jun. 21, 2024.

(30) Foreign Application Priority Data
Jun. 30, 2023 (CN) 202310802365.5
Sep. 11, 2023 (CN) 202311167898.7
Jan. 10, 2024 (CN) 202410040516.2
Jan. 10, 2024 (CN) 202410042473.1
Dec. 25, 2024 (CN) 202411934155.2

(51) Int. Cl. B62B 3/02; B25H 3/02; B62B 3/10; B62B 5/06

(52) U.S. Cl. CPC B62B 3/02; B25H 3/02; B62B 3/10; B62B 5/067

(57) ABSTRACT

A cart applicable to a storage box includes a walking assembly including rotatable wheels; a base plate assembly including a base plate, where the base plate is connected to the walking assembly, and the base plate assembly is at least partially disposed on the upper side of the walking assembly; a first support plate having at least a first state relative to the base plate, where when the first support plate is in the first state, the first support plate is connected to the base plate with an interval through at least one storage box.

### RELATED APPLICATION INFORMATION

This application is a continuation-in-part of International Application Number PCT/CN 2024/118109, filed on Sep. 11, 2024, through which this application claims the benefit under 35 U.S.C. § 119(a) of Chinese Patent Application No. 202311167898.7, filed on Sep. 11, 2023, Chinese Patent Application No. 202410042473.1, filed on Jan. 10, 2024, and Chinese Patent Application No. 202410040516.2, filed on Jan. 10, 2024.

This application is also a continuation-in-part of International Application Number PCT/CN 2024/100720, filed on Jun. 21, 2024, through which this application claims the benefit under 35 U.S.C. § 119(a) of Chinese Patent Application No. 202310802365.5, filed on Jun. 30, 2023.

This application further claims the benefit under 35 U.S.C. § 119(a) of Chinese Patent Application No. 202411934155.2, filed on Dec. 25, 2024.

Each of these applications to which priority is claimed is incorporated herein by reference in its entirety.

### TECHNICAL FIELD

The present application relates to a toolbox system, for example, a cart applicable to a storage box.

### BACKGROUND

Carts exist in the related art. A user generally needs to carry tools to be used when going to a workplace. To make it convenient for the user to carry and transport the tools, the user generally stores the tools in a storage box, where a charger, a battery pack, tool attachments, tools, and the like can be placed in the storage box. When the tools and the like are all placed in the storage box, the storage box is certainly very heavy during transportation, which is difficult for the user to transport. Therefore, the user often requires a cart to transport the storage box. However, most carts currently available on the market are bulky and cannot facilitate the transportation by users.

This part provides background information related to the present application, and the background information is not necessarily the existing art.

### SUMMARY

A cart applicable to a storage box includes a walking assembly including rotatable wheels; and a base plate assembly including a base plate, where the base plate is connected to the walking assembly, and the base plate assembly is at least partially disposed on the upper side of the walking assembly. The cart further includes a first support plate having at least a first state relative to the base plate, where when the first support plate is in the first state, the first support plate is connected to the base plate through at least one storage box.

A cart applicable to a storage box includes a walking assembly including rotatable wheels; and a base plate assembly including a base plate, where the base plate is connected to the walking assembly, and the base plate assembly is at least partially disposed on the upper side of the walking assembly. The cart further includes a first support plate, where the storage box is detachably connected to the base plate, the first support plate is detachably connected to the base plate through the storage box, and a space for storing items is formed on the upper side of the first support plate.

A cart applicable to a storage box includes a walking assembly including rotatable wheels; and a base plate assembly including a base plate, where the base plate is connected to the walking assembly, and the base plate assembly is at least partially disposed on the upper side of the walking assembly. The cart further includes a first support plate connected to the base plate through at least one storage box, where the storage box is formed with an opening that is openable and closable.

A cart includes a connecting device formed on or connected to the cart. The connecting device is configured to mount a to-be-mounted part onto the cart. The connecting device includes a base formed on or connected to the cart, where the base is formed with an accommodation cavity; and a connecting assembly connected to the base, where the connecting assembly is configured to be connected to the to-be-mounted part. The connecting assembly includes a connector mating with the to-be-mounted part to connect to the to-be-mounted part. The connecting assembly has at least a connection state and a hidden state relative to the base. When the connecting assembly is in the connection state, the connector is at a mating position so that the connector is capable of mating with the to-be-mounted part. When the connecting assembly is in the hidden state, the connector is at a hidden position so that the connector is separated from the mating position.

A toolbox includes a connecting device formed on or connected to the toolbox. The connecting device is configured to mount a to-be-mounted part onto the toolbox. The connecting device includes a base formed on or connected to the toolbox, where the base is formed with an accommodation cavity; and a connecting assembly connected to the base, where the connecting assembly is configured to be connected to the to-be-mounted part. The connecting assembly includes a connector mating with the to-be-mounted part to connect to the to-be-mounted part. The connecting assembly has at least a connection state and a hidden state relative to the base. When the connecting assembly is in the connection state, the connector is at a mating position so that the connector is capable of mating with the to-be-mounted part. When the connecting assembly is in the hidden state, the connector is at a hidden position so that the connector is separated from the mating position.

A tool includes a connecting device formed on or connected to the tool. The connecting device is configured to mount a to-be-mounted part onto the tool. The connecting device includes a base formed on or connected to the tool, where the base is formed with an accommodation cavity; and a connecting assembly connected to the base, where the connecting assembly is configured to be connected to the to-be-mounted part. The connecting assembly includes a connector mating with the to-be-mounted part to connect to the to-be-mounted part. The connecting assembly has at least a connection state and a hidden state relative to the base. When the connecting assembly is in the connection state, the connector is at a mating position so that the connector is capable of mating with the to-be-mounted part. When the connecting assembly is in the hidden state, the connector is at a hidden position so that the connector is separated from the mating position.

A connecting device capable of being mounted onto a tool or a toolbox is configured to mount a to-be-mounted part onto the tool or the toolbox. The connecting device includes a base formed on or connected to the tool or the toolbox, where the base is formed with an accommodation cavity; and a connecting assembly connected to the base, where the connecting assembly is configured to be connected to the to-be-mounted part. The connecting assembly includes a connector mating with the to-be-mounted part to connect the to-be-mounted part. The connecting assembly has at least a connection state and a hidden state relative to the base; when the connecting assembly is in the connection state, the connector is at a mating position so that the connector is capable of mating with the to-be-mounted part; and when the connecting assembly is in the hidden state, the connector is at a hidden position so that the connector is separated from the mating position.

A connecting device capable of being mounted onto a tool or a toolbox is configured to mount a to-be-mounted part onto the tool or the toolbox. The connecting device includes a base formed on or connected to the tool or the toolbox; and a connecting assembly connected to the base, where the connecting assembly is configured to be connected to the to-be-mounted part. The connecting assembly includes a connector mating with the to-be-mounted part to connect the to-be-mounted part. The connecting assembly has at least a hidden state relative to the base, where when the connecting assembly is in the hidden state, the connector is lower than the upper surface of the base or lower than the storage surface of the tool or the toolbox.

A cart applicable to a storage container includes: a walking assembly including rotary wheels; and a base plate assembly including a base plate, where the base plate is connected to the walking assembly, and the base plate assembly is at least partially disposed on the upper side of the walking assembly. The cart further includes: a first support plate, where the first support plate is configured to be connectable to the upper side of the base plate through at least one storage container; and a cover plate connected to the first support plate; where the first support plate is formed with an opening that is capable of accommodating at least part of the cover plate.

A cart applicable to a storage container includes: a walking assembly including rotary wheels; and a base plate assembly including a base plate, where the base plate is connected to the walking assembly, and the base plate assembly is at least partially disposed on the upper side of the walking assembly. The cart further includes a first support plate, where the first support plate is configured to be connectable to the upper side of the base plate through at least one storage container, and the first support plate is formed with an opening.

A cart applicable to a storage container includes: a walking assembly including rotary wheels; and a base plate assembly including a base plate, where the base plate is connected to the walking assembly, and the base plate assembly is at least partially disposed on the upper side of the walking assembly. The cart further includes: a support leg, where the support leg is connected to the base plate and is at least partially disposed on the upper side of the base plate; and a first support plate connected to the base plate through the support leg. A space above the base plate is defined as a first storage space, a space above the first support plate is defined as a second storage space, the first support plate is formed with an opening, and the opening allows the first storage space to communicate with the second storage space.

### BRIEF DESCRIPTION OF THE DRAWINGS

FIG. 1 is a perspective view of a cart applicable to a storage box in the present application.

FIG. 2 is a perspective view of the cart in FIG. 1 from another angle.

FIG. 3 is a perspective view of the cart in FIG. 1 from another angle.

FIG. 4 is a perspective view of the cart in FIG. 1 with items removed.

FIG. 5 is a perspective view of the cart in FIG. 4 from another angle.

FIG. 6 is a perspective view illustrating that the cart in FIG. 4 is separated from some external hangers, where the cart is in a first state.

FIG. 7 is a perspective view illustrating that a first support plate in FIG. 6 is separated from a pull rod and a storage box in FIG. 6, where the cart is in a third state.

FIG. 8 is a perspective view illustrating that a first support plate in FIG. 6 is directly connected to a base plate in FIG. 6, where the cart is in a second state and wheels are in an unfolded state.

FIG. 9 is a perspective view of the cart in FIG. 6 with a first support plate removed, where the cart is in a third state, a pull rod is in a used state, and a drive is in a connection state.

FIG. 10 is a perspective view of the cart when the pull rod in FIG. 9 is in a stored state and the drive in FIG. 9 is in a hidden state.

FIG. 11 is a perspective view of the cart in FIG. 1, with a pull rod in a stored state, the cart in a second state, and wheels in a folded state.

FIG. 12 is a perspective view of the cart in FIG. 11 from another angle, where the wheels are in the folded state.

FIG. 13 is an exploded view of a locking device of the cart in FIG. 11.

FIG. 14 is a perspective view of a first support plate in FIG. 1.

FIG. 15 shows a second example in which a first support plate is connected to a base plate through storage boxes.

FIG. 16 is a perspective view of a cart in FIG. 15 with items removed.

FIG. 17 is a perspective view illustrating that a first support plate in FIG. 16 is separated from a base plate in FIG. 16.

FIG. 18 is a perspective view of a second type of first support plate in FIG. 15.

FIG. 19 is a perspective view illustrating that the pull rod in FIG. 9 is in a separated state.

FIG. 20 is a perspective view of another feasible example of a locking device of the present application, where wheels are in a traveling state and clasps are in a locking state.

FIG. 21 is a perspective view of part of the structure of a cart in FIG. 20, where wheels are in a folded state and a clasp is in the locking state.

FIG. 22 is a perspective view of part of the structure of a cart in FIG. 20, where wheels are in a traveling state and a clasp is in a release state.

FIG. 23 is a perspective view of part of the structure of a cart in FIG. 20, where a clasp is in a release state and an adapter is in a second state.

FIG. 24 is a partial enlarged view of the perspective view of FIG. 23.

FIG. 25 is a perspective view of another feasible example of a locking device of the present application.

FIG. 26 is a perspective view of part of the structure of a cart in FIG. 25, where wheels are in a folded state.

FIG. 27 is a sectional view of the cart shown in FIG. 26.

FIG. 28 is a perspective view of part of the structure of a cart in FIG. 25, where wheels are in a traveling state.

FIG. 29 is an exploded view of the cart shown in FIG. 26.

FIG. 30 is a schematic view of connecting devices applied to a cart according to the present application.

FIG. 31 is a schematic view of connecting devices applied to a utility terrain vehicle (UTV) according to the present application.

FIG. 32 is a schematic view of connecting devices applied to a toolbox according to the present application.

FIG. 33 is a perspective view of a connecting device according to an example of the present application, where a connecting assembly is in a connection state.

FIG. 34 is a perspective view of a position of the connecting assembly in FIG. 33 switching from the connection state to a hidden state.

FIG. 35 is a perspective view of the connecting assembly in FIG. 33 in a hidden state.

FIG. 36 is a sectional view of the connecting device in FIG. 33.

FIG. 37 is a sectional view of a connecting device in FIG. 35.

FIG. 38 is a perspective view illustrating that the connecting assembly in FIG. 33 and a base are separated.

FIG. 39 is a perspective view of a connecting device according to an example of the present application, where a connecting assembly is in a connection state.

FIG. 40 is a perspective view of the connecting assembly in FIG. 39 in a hidden state.

FIG. 41 is a sectional view of the connecting device in FIG. 39.

FIG. 42 is a sectional view of a connecting device in FIG. 40.

FIG. 43 is a perspective view illustrating that the connecting assembly in FIG. 39 and a base are separated.

FIG. 44 is a perspective view illustrating that the connecting assembly in FIG. 43 and the base are separated from another perspective.

FIG. 45 is a perspective view of a connecting device according to an example of the present application, where a connecting assembly is in a connection state.

FIG. 46 is a perspective view of the connecting assembly in FIG. 45 in a hidden state.

FIG. 47 is a sectional view of a connecting device in FIG. 46.

FIG. 48 is a sectional view of the connecting device in FIG. 45.

FIG. 49 is a perspective view illustrating that the connecting assembly in FIG. 45, a driving member, and a base are separated.

FIG. 50 is a perspective view of a connecting device according to an example of the present application, where a connecting assembly is in a connection state.

FIG. 51 is a perspective view of the connecting assembly in FIG. 50 in a hidden state.

FIG. 52 is a sectional view of the connecting device in FIG. 50.

FIG. 53 is a sectional view of a connecting device in FIG. 51.

FIG. 54 is a perspective view illustrating that the connecting assembly in FIG. 50, a driving member, and a base are separated.

FIG. 55 is a perspective view illustrating that the connecting assembly in FIG. 54, the driving member, and the base are separated from another perspective.

FIG. 56 is a perspective view of a connecting device according to an example of the present application, where a connecting assembly is in a connection state.

FIG. 57 is a perspective view of the connecting assembly in FIG. 56 in a hidden state.

FIG. 58 is a perspective view illustrating that the connecting assembly in FIG. 56 is separated upward.

FIG. 59 is a perspective view illustrating that the connecting assembly in FIG. 56 is mounted downward.

FIG. 60 is a partial enlarged view of FIG. 30.

FIG. 61 is a schematic view of the use of a cart in the present application.

FIG. 62 is a schematic view of the cart shown in FIG. 61 from another angle of view.

FIG. 63 is a schematic view of the use of the cart shown in FIG. 61 without a cover plate mounted.

FIG. 64 is a schematic view showing that no item is placed on the cart shown in FIG. 61.

FIG. 65 is a schematic view showing that elongated items and accessory boxes are mounted in the cart shown in FIG. 64 through a first type of cover plate.

FIG. 66 is a schematic view showing that accessory boxes are mounted in the cart shown in FIG. 64 through a first type of cover plate.

FIG. 67 is a schematic view showing that a first type of cover plate is used in conjunction with a second type of cover plate in the cart shown in FIG. 64.

FIG. 68 is a schematic view showing that a first type of cover plate is used in conjunction with a second type of cover plate in the cart shown in FIG. 64.

FIG. 69 is a schematic view showing that a first type of cover plate is mounted to a first support plate in the cart shown in FIG. 64.

FIG. 70 is a schematic view showing that two cover plates of a second type are mounted to a first support plate in the cart shown in FIG. 64.

FIG. 71 is a schematic view showing that a third type of cover plate is mounted to a first support plate in the cart shown in FIG. 64.

FIG. 72 is an exploded view of the cart in FIG. 64 and a cover plate, where the cover plate and a first support plate are connected to each other through screws.

FIG. 73 is an exploded view of the cart in FIG. 64 and a cover plate, where the cover plate and a first support plate are connected to each other through snaps.

FIG. 74 is a schematic view showing that multiple cover plates are mounted to a first support plate in the cart shown in FIG. 61.

FIG. 75 is a schematic view showing that multiple cover plates are mounted to a first support plate in the cart shown in FIG. 61.

FIG. 76 is a schematic view showing that multiple cover plates are mounted to a first support plate in the cart shown in FIG. 61.

FIG. 77 is a schematic diagram of a cart in which a first support plate is connected to a base plate through two storage containers.

FIG. 78 is a schematic diagram of a cart in which a first support plate is connected to a base plate through support legs and a pull rod.

FIG. 79 is a schematic diagram of a cart in which a first support plate is connected to a base plate through support legs.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies □ one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

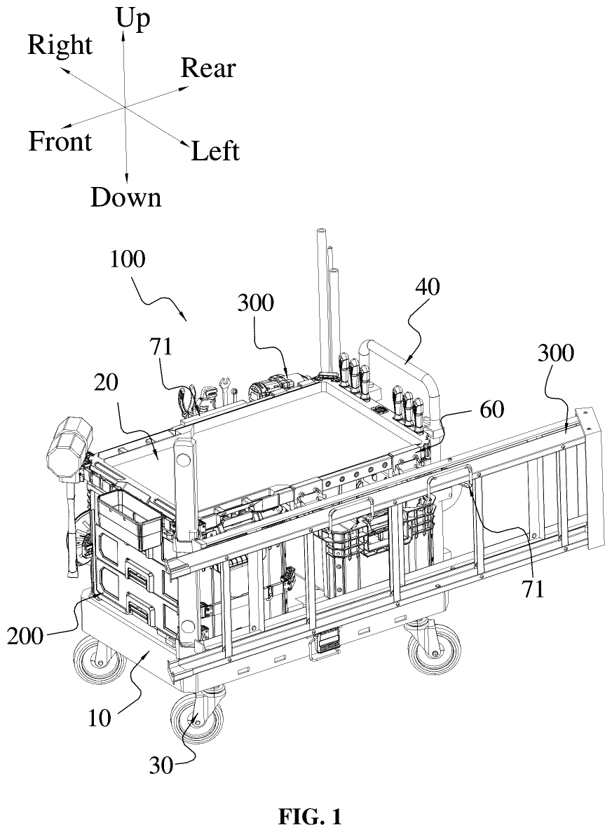

FIG. 1 shows a cart 100 applicable to the transportation and placement of a storage box 200. From the viewpoint of working conditions, a user generally needs to carry items 300 to be used when going to a workplace. To make it convenient for the user to carry and transport the items 300, the user generally stores the items 300 in the storage box 200. The user may place, hang, or fix the storage box 200 or tools on or to the cart 100 so that the user may use the cart 100 to transport the storage box 200 to the workplace, place the tools in the workplace, or mount a workbench on the cart 100, where the workbench serves as a temporary workbench for placing a machine or is set as a temporary office space.

The items 300 refer to one or a combination of an attachment, a tool, a charging device, a power supply device, a lighting device, an accessory box/bag, a toolbox, an auxiliary tool, and the like.

To clearly describe the structure of the cart 100 and working principles thereof, up, down, front, rear, left, and right are defined, as shown in FIG. 1. It is to be noted that, unless otherwise specified, up and down, front and rear, and left and right are described below with respect to a stationary state shown in FIG. 1.

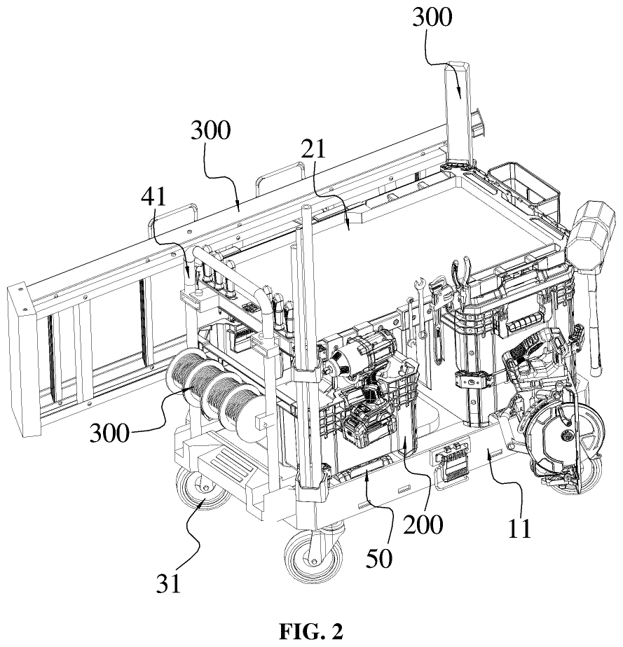

As shown in FIGS. 1 to 5, the cart 100 includes a base plate assembly 10, a first support assembly 20, a walking assembly 30, and a pull rod assembly 40.

The walking assembly 30 is connected to the base plate assembly 10. In an up and down direction, the walking assembly 30 is disposed under the base plate assembly 10, the walking assembly 30 includes one or more wheels 31, and the walking assembly 30 enables the base plate assembly 10 to move relative to the ground. The user may push or pull the pull rod assembly 40 so that the wheels 31 rotate relative to the ground and drive the base plate assembly 10 to move. It is to be noted that the ground is not limited to the ground surface and may refer to another contact surface for placing the cart 100.

The base plate assembly 10 is at least partially disposed on the walking assembly 30. The base plate assembly 10 includes a base plate 11, and the wheels 31 are substantially mounted at the lower end of the base plate 11. The base plate 11 is configured for stacking the storage box 200, the attachment, the tool, the charging device, the power supply device, the lighting device, and the like. Of course, the attachment, the tool, the charging device, the power supply device, and the lighting device may be placed in the storage box 200, and then the storage box 200 may be placed on the base plate 11.

The pull rod assembly 40 is connected to the base plate assembly 10. The pull rod assembly 40 includes a pull rod 41, the pull rod 41 includes a first connecting rod 42 and a second connecting rod 43 opposite to each other and substantially extending along a direction of a straight line and a grip rod 44 connecting an end of the first connecting rod 42 to an end of the second connecting rod 43, the user holds the grip rod 44 to drive the cart 100 to move, and the other end of the first connecting rod 42 and the other end of the second connecting rod 43 are pivotally connected to the base plate 11. The pull rod 41 is rotatably connected to the base plate 11. During rotation, the pull rod 41 has at least a stored state and a used state. The base plate 11 is formed with an upper recess 12. When the pull rod 41 is in the stored state, the pull rod 41 is stored in the upper recess 12, and the pull rod 41 is lower than an upper surface 13 of the base plate 11. When the pull rod 41 is in the used state, the pull rod 41 and the base plate 11 are at a certain angle. The specific angle between the pull rod 41 and the base plate 11 is not limited, and the pull rod 41 may rotate relative to the base plate 11 steplessly or in a gear adjustment manner. In this example, the pull rod 41 rotates relative to the base plate 11 steplessly, that is, the user may rotate the pull rod 41 as required by the user. In other examples, the pull rod 41 further has a separated state relative to the base plate 11, that is, the pull rod 41 may be detached from the base plate 11, as shown in FIG. 19.

The first support assembly 20 is disposed on the upper side of the base plate assembly 10. The first support assembly 20 includes a first support plate 21 disposed at the upper end of the base plate 11. The first support plate 21 has at least a first state, a second state, and a third state relative to the base plate 11. When the first support plate 21 is in the first state, the first support plate 21 is connected to the base plate 11 through at least one storage box 200. When the first support plate 21 is in the second state, the first support plate 21 is directly mounted on the base plate 11. When the first support plate 21 is in the third state, the first support plate 21 is separated from the base plate 11. In this manner, the user can select different states according to actual working conditions, greatly increasing the diversity of functions of the cart 100. Of course, the user may dispose a second support assembly, a third support assembly, or the like on the first support plate 21 through the storage box 200. Additionally, when the first support plate 21 is in any one state, the state can be used in combination with three states of the pull rod 41 relative to the base plate 11 so that the user can select use states according to the current working condition, facilitating operations.

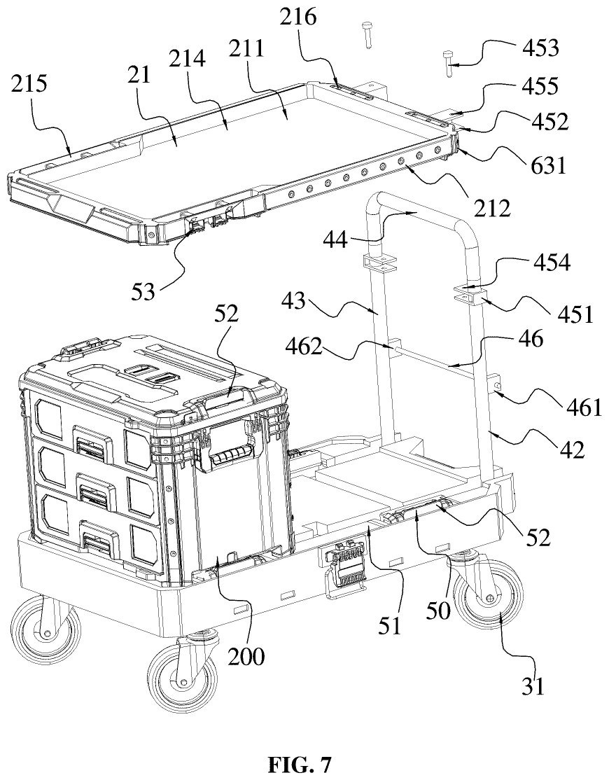

In conjunction with FIG. 7, the cart 100 further includes a first connection assembly 45 configured to connect the pull rod assembly 40 to the first support assembly 20 and to fixedly connect the pull rod 41 to the first support plate 21. The user may mount the first support plate 21 above the base plate 11 through the first connection assembly 45 and the storage box 200. To ensure the connection stability between the pull rod 41 and the first support plate 21, the first connection assembly 45 may be mounted on each of the first connecting rod 42 and the second connecting rod 43, where one first connection assembly 45 mounted on the first connecting rod 42 is described herein.

When the user needs to switch the cart 100 to the first state, as a feasible example, the user may mount the first support plate 21 onto the base plate 11 through the first connection assembly 45 and the storage box 200. The first connection assembly 45 includes a first connector 451 and a second connector 452. When the first connector 451 is connected to the second connector 452, the first support plate 21 is fixedly connected to the first connecting rod 42. When the first connector 451 is separated from the second connector 452, the first support plate 21 is separated from the first connecting rod 42, and the pull rod 41 may rotate relative to the base plate 11. The first connector 451 is connected to or formed on the first connecting rod 42, the second connector 452 is connected to or formed on the first support plate 21, and the first connector 451 and the second connector 452 may be connected in multiple manners, that is, the first connector 451 and the second connector 452 may be connected through one or a combination of threads, a mortise-and-tenon joint, a screw, a latch, and a snap-fit. A specific connection manner between the first connector 451 and the second connector 452 is not limited as long as the first connector 451 and the second connector 452 can be connected and remain relatively fixed.

In this example, the first connection assembly 45 further includes a fastener 453, and the first connector 451 is connected to the second connector 452 by the fastener 453. As a specific example, the first connector 451 is formed on the first connecting rod 42, the second connector 452 is formed on the first support plate 21, the first connector 451 is formed with first connection holes 454 through the first connector 451, and the second connector 452 is formed with second connection holes 455 through the second connector 452. When the user needs to fixedly connect the pull rod 41 to the first support plate 21, the first connection holes 454 are aligned with the second connection holes 455, and then the fastener 453 penetrates through the first connection holes 454 and the second connection holes 455 so that the first connector 451 is fixedly connected to the second connector 452. When the user needs to separate the pull rod 41 from the first support plate 21, the user simply pulls the fastener 453 out from the first connection holes 454 and the second connection holes 455, and the first connector 451 and the second connector 452 can move freely relative to each other so that the user can separate the pull rod 41 from the first support plate 21 and perform state switching. In this example, the fastener 453 is simply inserted or removed so that the first support plate 21 can be fixed to or separated from the pull rod 41 so that the structure is simple and convenient for the user to use. When the first connector 451 and the second connector 452 are fixed by the fastener 453, the grip rod 44 of the pull rod 41 is located above the first support plate 21 along the up and down direction, making it convenient for the user to hold the grip rod 44 to push/pull the cart 100.

With continued reference to FIG. 7, the cart 100 further includes a holder 46 detachably connected to the pull rod 41. The holder 46 may be configured for a cable to be sleeved on. Of course, other items 300 may be hung on the holder 46. The holder 46 is specifically an elongated rod, where one end of the holder 46 is connected to the first connecting rod 42 and the other end of the holder 46 is connected to the second connecting rod 43. The holder 46 is connected to the first connecting rod 42 and/or the second connecting rod 43 through one or a combination of a snap-fit, threads, a screw, a mortise-and-tenon joint, and a latch. In this example, the holder 46 is connected to the first connecting rod 42 and the second connecting rod 43 through latch connections. The first connecting rod 42 is connected to a first insertion portion 461, the second connecting rod 43 is connected to a second insertion portion 462, the first insertion portion 461 and the second insertion portion 462 correspond to each other, and the first insertion portion 461 and the second insertion portion 462 are provided with penetrating through holes. The holder 46 may penetrate through the through holes on the first insertion portion 461 and the second insertion portion 462 so that the holder 46 is directly connected to the pull rod 41. When the user needs to use the holder 46, as an example, the user may penetrate one end of the holder 46 through one through hole, sleeve the cable on the holder 46, and penetrate the one end of the holder 46 through the other through hole so that the cable can be connected to the holder 46. Of course, the cable here may be another item 300. As another example, two ends of the holder 46 directly penetrate through the through holes on the first connecting rod 42 and the second connecting rod 43, and the user may hang the item 300 on the holder 46 with a hook. When the user needs to use the item 300, the user may directly take the item 300 off the holder 46. In other examples, the user may detach the holder 46 from the pull rod 41 and mount the holder 46 onto the pull rod 41 when some items 300 need to be hung or sleeved on the holder 46. This arrangement can not only increase a space for placing the items 300 on the cart 100 but also make it convenient for the user to access or store the items 300. Moreover, the structure is simple and facilitates operations.

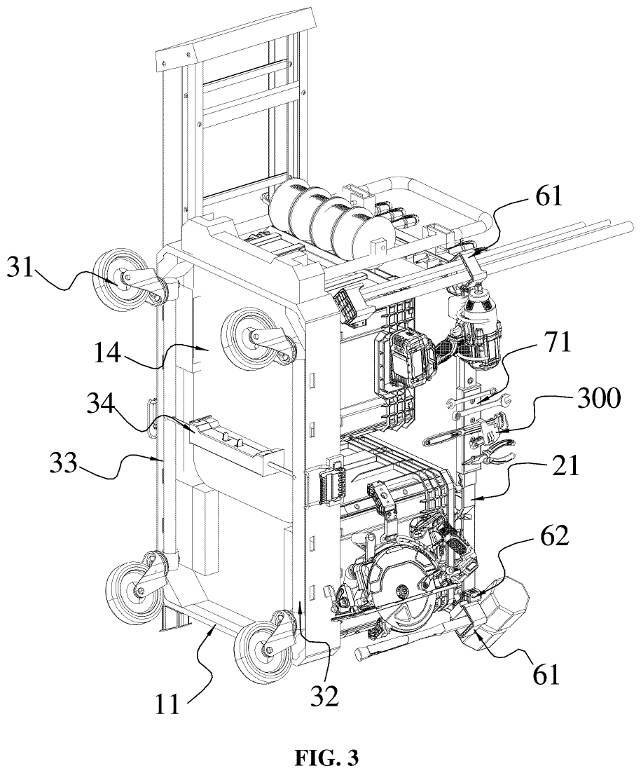

Referring to FIG. 3, the walking assembly 30 includes four wheels 31 mounted at the lower end of the base plate 11, and the wheels 31 can be driven to rotate relative to the base plate 11. During rotation, the wheels 31 have a folded state and an unfolded state. When the wheels 31 are in the folded state, the wheels 31 are located within a lower recess 14 of the base plate 11, and the wheels 31 are separated from the ground. When the wheels 31 are in the unfolded state, the wheels 31 are in contact with the ground. In this manner, when the user wants to use the cart 100, the user simply switches the wheels 31 to the unfolded state so that the user can push the wheels 31 to drive the cart 100 to walk. When the user wants to store the cart 100, the user simply switches the wheels 31 to the folded state so that the cart 100 can be stored in a storage place or placed in a pickup truck for transportation.

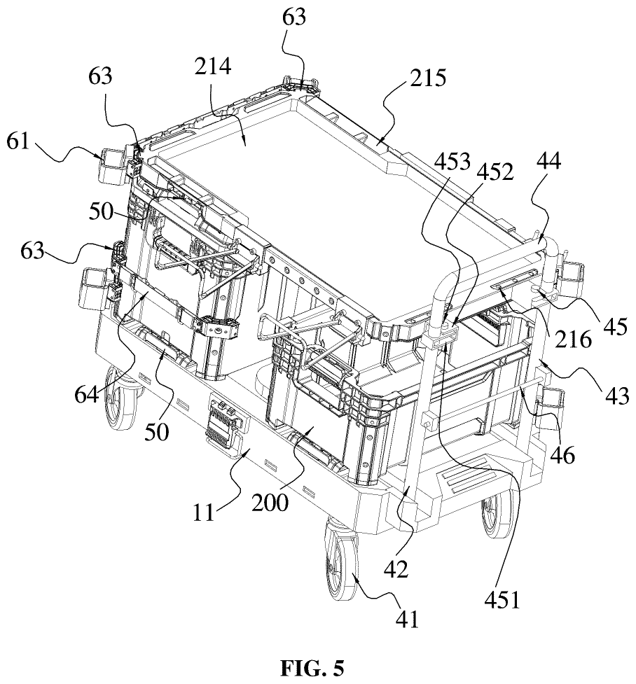

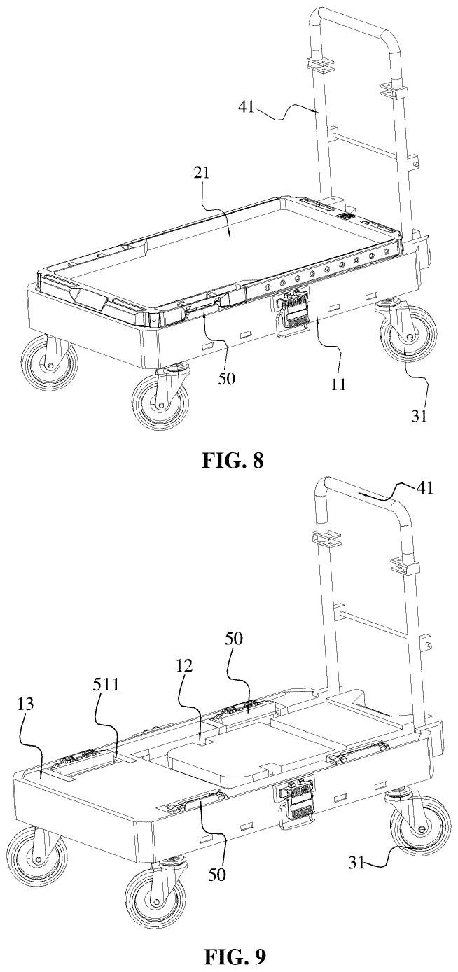

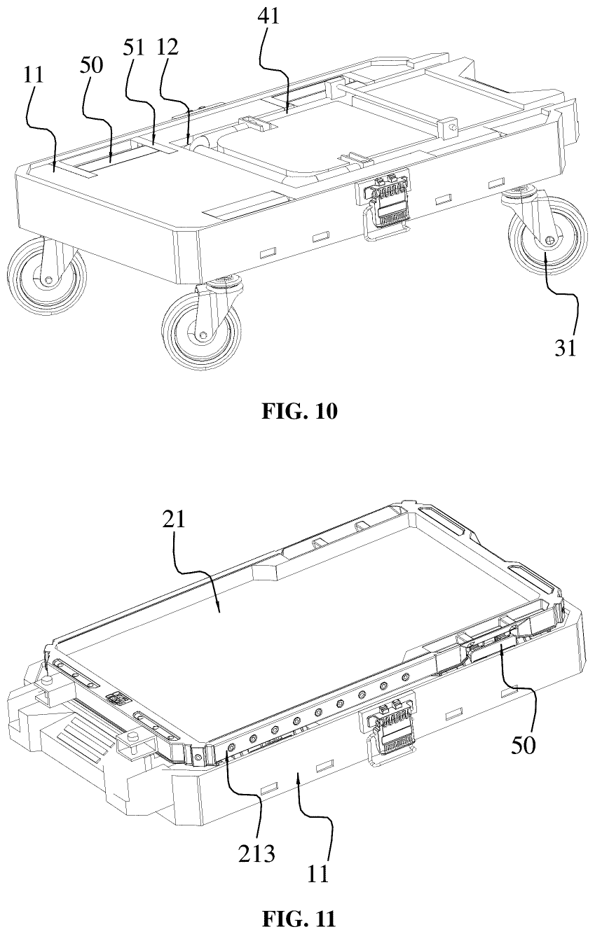

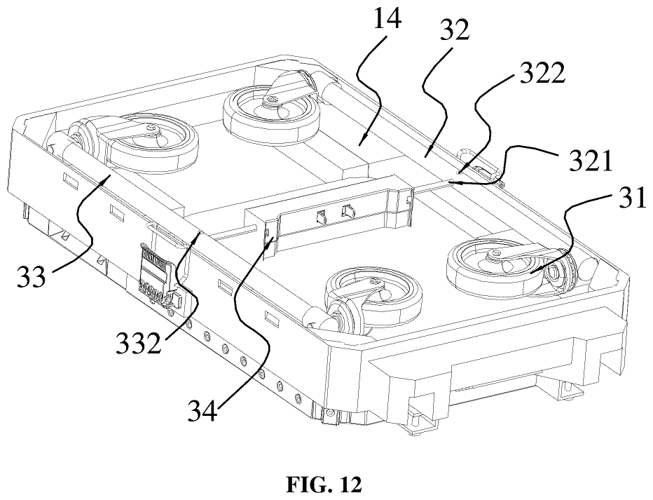

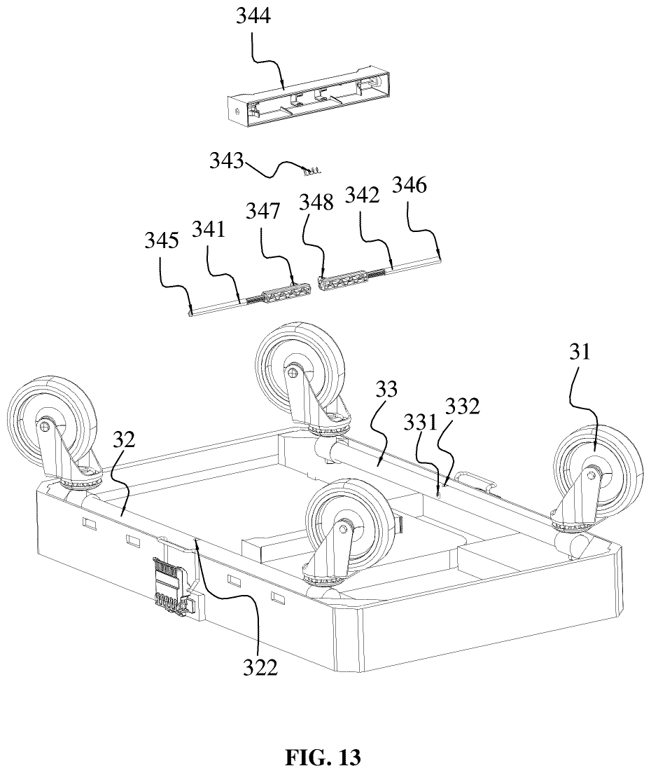

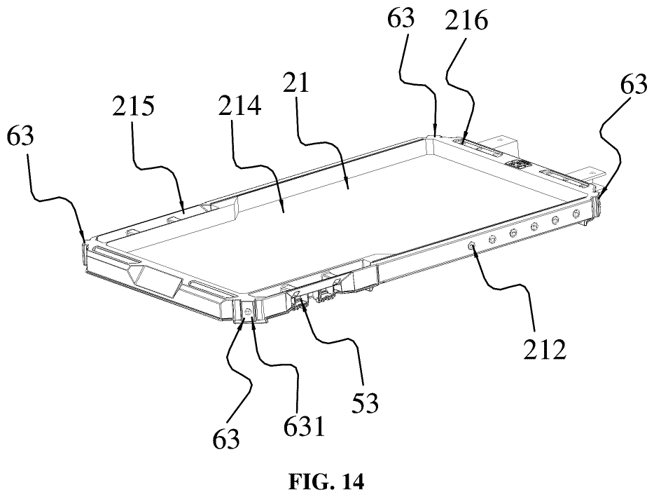

Referring to FIGS. 5 to 14, the cart 100 further includes a second connection assembly 50 configured to connect the storage box 200 to the base plate 11 and to connect the first support plate 21 to the storage box 200. To ensure connection stability, second connection assemblies 50 may be symmetrically mounted at two ends of each of the base plate 11, the first support plate 21, and the storage box 200. Here, one second connection assembly 50 is described in detail as an example. Second connection assemblies 50 disposed opposite may be referred to as a set of connection devices.

The second connection assembly 50 includes a base 51, a drive 52, and an adapter 53. The drive 52 is mounted on the base 51, the drive 52 is movable relative to the base 51, and the drive 52 can be separated from or connected to the adapter 53. The base 51 may be connected to or formed on the cart 100. It is to be understood that the base 51 may be connected to or formed on the base plate 11. As a feasible example, the base 51 is directly formed on the base plate 11, and multiple bases 51 may be provided on the base plate 11. That is to say, multiple sets of connection devices may be mounted on the base plate 11. In this manner, the user can connect multiple storage boxes 200 to the base plate 11.

The drive 52 can move relative to the base 51, that is, the drive 52 has at least two states relative to the base 51, which are a hidden state and a connection state, respectively. When the drive 52 is in the connection state, the drive 52 is at a mating position where the drive 52 can mate with the adapter 53. In this case, the drive 52 can be connected to the adapter 53. When the drive 52 is in the hidden state, the drive 52 is at a hidden position where the drive 52 is removed from the mating position. In this example, the drive 52 is connected to the base plate 11, and the adapter 53 is connected to or formed on the storage box 200 and/or the first support plate 21. As an example, the adapter 53 is formed on the storage box 200. When the drive 52 is in the connection state, the drive 52 can be locked to the adapter 53 so that the storage box 200 can be fixedly connected to the base 51. When the drive 52 is in the hidden state, the drive 52 is separated from the adapter 53, and a top surface of the drive 52 along the up and down direction is lower than or flush with the upper surface 13 of the base 51. In this manner, when the user wants to mount the storage box 200 on the base plate 11, the user simply switches the drive 52 to the connection state, and when the user does not need to use the second connection assembly 50, the user simply switches the drive 52 to the hidden state so that the user can stack other items 300 on the base plate 11 without damaging the second connection assembly 50, and the second connection assembly 50 does not interfere with the items 300. That is, the cart 100 has increased diversity of functions and is convenient for the user to use. It is to be noted that the adapter 53 is not necessarily formed on the storage box 200 and may be formed on another item 300 as long as the adapter 53 can be connected to the drive 52.

Specifically, the base 51 is formed with an accommodation cavity 511, and the drive 52 may be disposed in the accommodation cavity 511. The drive 52 may be accommodated in the accommodation cavity 511, the drive 52 is pivotally connected to the base 51, and the drive 52 can rotate relative to the base 51. When the user needs to switch the drive 52 to the connection state, the user simply turns the drive 52 upward to rotate the drive 52 to the mating position. When the user does not need to use the second connection assembly 50, the user simply turns the drive 52 downward to rotate the drive 52 to the hidden position, that is, flips the drive 52 into the accommodation cavity 511.

The first support plate 21 may be mounted on the base plate 11. It is to be understood that the first support plate 21 may be spaced apart from the base plate 11; of course, the first support plate 21 may be directly connected to the base plate 11. The first support plate 21 is connected to the base plate 11 with an interval, that is, the first support plate 21 is connected to the base plate 11 through the first connection assembly 45 and the storage box 200. Along the up and down direction, the storage box 200 is provided with two sets of connection devices. The storage box 200 has an upper top surface and a lower bottom surface opposite to each other, one set of connection devices may be mounted on the upper top surface of the storage box 200, and one set of connection devices may be mounted on the lower bottom surface of the storage box 200. The adapter 53 may be mounted on the lower bottom surface of the storage box 200, and the drive 52 may be mounted on the base plate 11. The user may connect the storage box 200 to the base plate 11 by connecting the adapter 53 to the drive 52. The drive 52 may be mounted on the upper top surface of the storage box 200, the adapter 53 may be mounted at the lower end of the first support plate 21, and the adapter 53 on the first support plate 21 may be connected to the drive 52 on the storage box 200 so that the first support plate 21 is mounted to the upper end of the storage box 200. In this case, the first support plate 21 is in the first state. In this example, the pull rod 41 and the storage box 200 are used to replace support legs between the first support plate 21 and the base plate 11. In this manner, during actual use, the user may directly use the first support plate 21, the storage box 200, and the pull rod 41 to change a single-layer cart 100 to a double-layer cart 100, that is, one storage space is formed on the upper side of each of the base plate 11 and the first support plate 21 so that the user can directly place the items 300 on the base plate 11 and the first support plate 21 without additionally mounting the support legs, thereby simplifying the structure and facilitate operations of the user.

The first support plate 21 may be directly mounted onto the base plate 11 through the second connection assembly 50. That is, the adapter 53 on the first support plate 21 may be directly connected to the drive 52 on the base plate 11 so that the first support plate 21 can be directly connected to the base plate 11. In this case, the first support plate 21 is in the second state, that is, the cart 100 changes to the single-layer cart 100, and the user can directly place the items 300 on the first support plate 21. In another example of the cart 100, the first support plate 21 is not mounted on the base plate 11, that is to say, the first support plate 21 is in the third state. That is, only the base plate 11 forms the cart 100 with the pull rod 41, the user may place the items 300 on the base plate 11, and the user pushes/pulls the cart 100 through the pull rod 41. As another example in which the first support plate 21 is not mounted, the pull rod 41 may be stored in the upper recess 12 so that the cart 100 changes to a platform cart 100. The user may directly place the items 300 on the base plate 11, for example, stack multiple storage boxes 200, and the user may directly push the storage box 200 to drive the wheels 31 to move. To sum up, according to the current working condition, the user can quickly and conveniently switch the cart 100 to a configuration suitable for the current working condition to facilitate use.

The cart 100 may also be connected to an external hanger assembly 60 configured to connect the items 300 to the cart 100 and/or the storage box 200. The external hanger assembly 60 includes at least one external hanger 61, the external hanger 61 includes a mounting portion 611 and a connection portion 612, the mounting portion 611 is configured to detachably connect the item 300, and the connection portion 612 is configured to be mounted onto the cart 100 and/or the storage box 200. In this manner, the user can mount the item 300 on the storage box 200 or the cart 100, and since the item 300 is mounted in outside space, the item 300 is more convenient for the user to place or take off. The item 300 may be connected to the external hanger 61 through one or a combination of insertion and removal, hanging, snap-fit, attraction, and the like.

The external hanger assembly 60 further includes an intermediate piece 62 capable of mating with the external hanger 61, the external hanger 61 is mounted on the cart 100 and/or the storage box 200 through the intermediate piece 62, and one or more intermediate pieces 62 and one or more external hangers 61 may be provided. The storage box 200, the base plate 11, and the first support plate 21 are each formed with a connection section 63, the connection section 63 is specifically formed at a corner of the storage box, the base plate 11, or the first support plate 21, and a guard rod is embedded in the connection section 63, where the guard rod is made of a metal material. One or more intermediate pieces 62 may be mounted on the connection section 63. The intermediate piece 62 may be connected to the connection section 63 through one or a combination of a screw, a latch, a rivet, and a movable snap. In this example, the intermediate piece 62 is mounted onto the connection section 63 through a screw connection, that is, the intermediate piece 62 is fixed to the connection section 63 by the screw. Of course, it is to be understood that the connection section 63 is formed with a connection surface 631, multiple positioning holes 632 are provided on the connection surface 631, and the intermediate piece 62 is formed with a mounting hole 621. The user may align the mounting hole 621 on the intermediate piece 62 with a corresponding positioning hole 632 as required and then fix the holes with the screw so that the intermediate piece 62 is fixed to the connection section 63. One or more external hangers 61 are detachably mounted to the intermediate piece 62. That is to say, multiple external hangers 61 may all be mounted to the intermediate piece 62. The external hanger 61 may be connected to the intermediate piece 62 through one or a combination of screws, a latch, rivets, and a movable snap. In this example, the external hanger 61 is mounted onto the intermediate piece 62 through screw connections. Multiple external hangers 61 are provided, and the external hanger 61 includes one or a combination of a battery pack hanger, a cable hanger, a scale hanger, a support 64, and a power tool hanger. In this manner, the user may mount necessary items 300 on the storage box 200 or the cart 100 according to an actual working condition. As a feasible example, the user may mount intermediate pieces 62 on two adjacent connection sections 63, connect one end of the support 64 to one intermediate piece 62, and connect the other end of the support 64 to the other intermediate piece 62. The support 64 is provided with multiple slots arranged at intervals, and the user may clamp a tool in a slot with a hook.

The first support plate 21 includes a first surface 211 and a second surface 212 and a third surface 213 located on sidewalls of the first support plate 21. The first surface 211 is recessed downward to form a first recess 214, and the user may place the storage box 200 or directly place the items 300 in the first recess 214. The first surface 211 is also recessed downward to form multiple small recesses 215, and the user may place some small items 300, such as saw blades, drill bits, and screws, in the small recesses 215. The first surface 211 further includes multiple insertion slots 216 recessed downward and configured for placing tools such as screwdrivers. The second surface 212 and the third surface 213 are opposite to each other, the adapter 53 mating with the drive 52 is provided on each of the second surface 212 and the third surface 213, and positioning portions are further provided on the second surface 212 and the third surface 213 so that the user may directly mount, hang, or attract the attachment, the tool, the charging device, the power supply device, the lighting device, and the like on or to the second surface 212 and the third surface 213. The external hanger 61 may be mounted onto the second surface 212 and/or the third surface 213 through one or more of a magnetic member, a screw connection, a snap connection, and a hook connection.

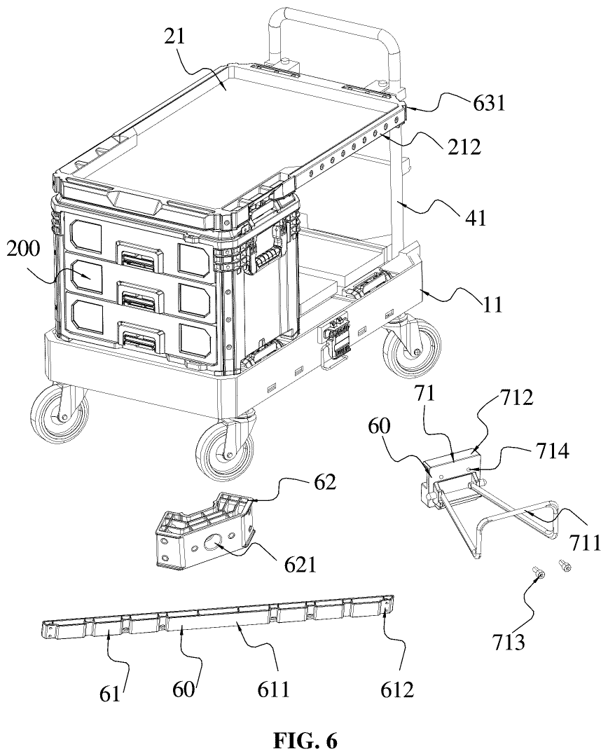

As shown in FIG. 6, as a feasible example, the external hanger assembly 60 further includes one or more external hangers 71 and one or more fasteners 713 for mounting the external hangers 71 to the cart 100, where the fasteners 713 can penetrate through the external hangers 71 and be connected to the first support plate 21. An external hanger 71 includes a connection portion 712 and a mounting portion 711, the mounting portion 711 is configured to detachably connect an item 300, and the connection portion 712 is configured to be connected to fasteners 713 to fixedly connect the external hanger 71 to the first support plate 21. Multiple positioning grooves are provided on the second surface 212 and/or the third surface 213, and the connection portion 712 is provided with holes 714. After the fasteners 713 penetrate through the holes 714, the external hanger 71 is driven to be fixed into positioning grooves where the external hanger 71 is required to be fixed. In this example, the fasteners 713 may be threadedly connected to the positioning grooves, that is, the fasteners 713 may be screws. The external hanger 71 and the external hanger 61 may both be mounted on the cart 100.

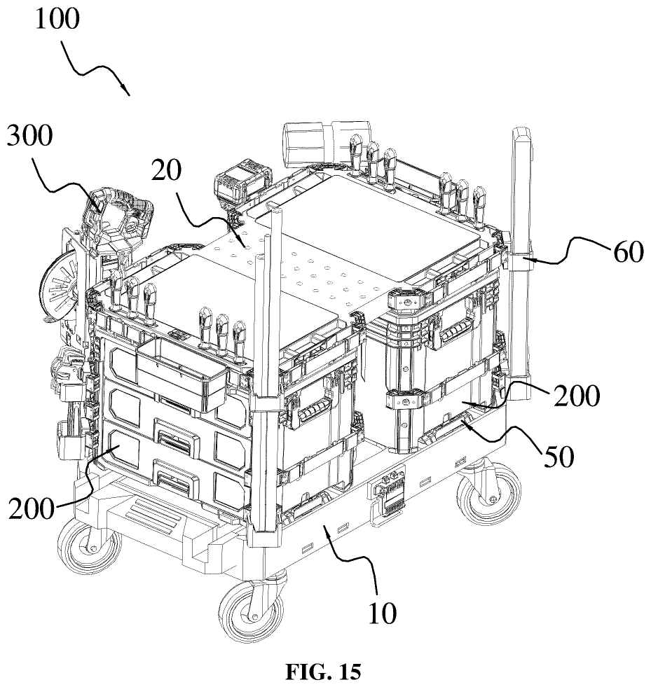

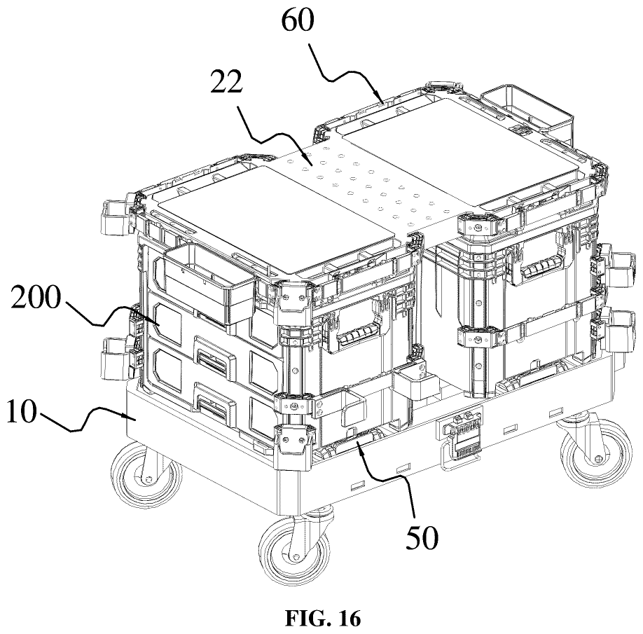

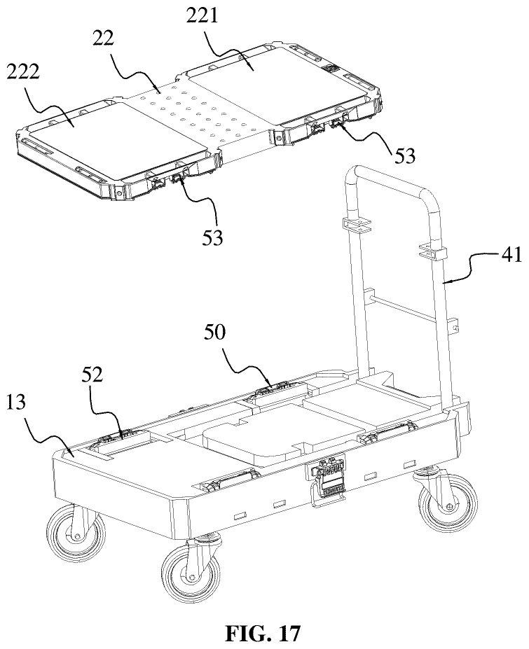

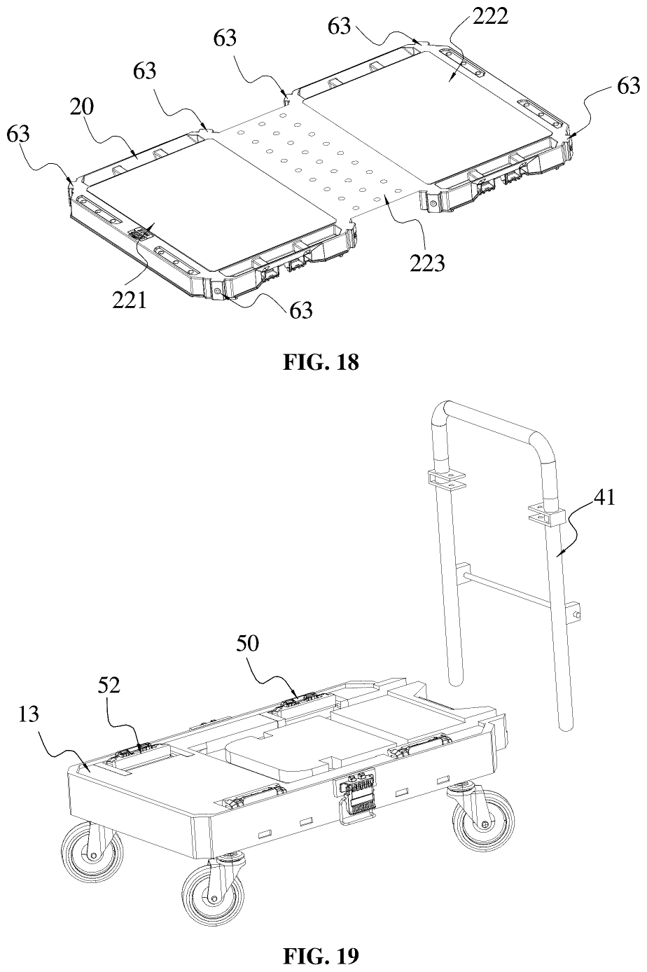

FIGS. 15 to 18 show a first support plate 22 as a second example. It is to be noted that the cart 100, the storage box 200, and the external hanger assembly 60 have substantially the same structures in the second example and the first example, and example two differs from example one only in that the first support plate 22 has a different structure, the first support plate 22 is connected to the cart 100 in a different manner, and the external hanger assembly 60 are mounted at different positions. Differences between example two and example one are described here, and for other structures, reference may be made to the preceding description and the details are not repeated here. During actual use, the user may switch the first support plate 21 in example one and the first support plate 22 in example two between each other as required.

The first support plate 22 may be indirectly connected to the base plate 11 through at least two storage boxes 200 or may be directly connected to the base plate 11 through the second connection assembly 50.

The first support plate 22 specifically includes a first working plate 221, a second working plate 222, and a connecting plate 223 for connecting the first working plate 221 to the second working plate 222. The first working plate 221 and the second working plate 222 are each mounted with the adapter 53 mating with the drive 52.

Two storage boxes 200 are mounted on the base plate 11. Along the up and down direction, each storage box 200 is provided with two sets of connection devices. The storage box 200 has the upper top surface and the lower bottom surface opposite to each other, one set of connection devices may be mounted on the upper top surface of the storage box 200, and one set of connection devices may be mounted on the lower bottom surface of the storage box 200. The adapter 53 may be mounted on the lower bottom surface of the storage box 200, and the drive 52 may be mounted on the base plate 11. The user may connect the storage box 200 to the base plate 11 by connecting the adapter 53 to the drive 52. The drive 52 may be mounted on the upper top surface of the storage box 200, the adapter 53 on the first working plate 221 is connected to the drive 52, and similarly, the adapter 53 on the second working plate 222 is connected to the drive 52 on the other storage box 200, so that the first support plate 22 is mounted to the upper end of the storage boxes 200. In this case, the first support plate 22 is in the first state. In the first state, the cart 100 may have two examples. In one example, the user flips the pull rod 41 out of the upper recess 14 and may push/pull the pull rod 41 to move the cart 100. In the other example, the user stores the pull rod 41 in the upper recess 14 and pushes the base plate 11, the storage box 200, or the first support plate 22 to move the cart 100. In the first state, the user may use the first support plate 22 as a workbench, and the user may place a tool on the first support plate 22 to cut a workpiece or the like on the first support plate 22, or the user may perform operations such as writing and drawing on the first support plate 22.

The first support plate 22 may be directly mounted on the base plate 11, that is, the drive 52 on the base plate 11 is connected to the adapter 53 on the first support plate 22 so that the first support plate 22 is fixed to the base plate 11. In this case, the first support plate 22 is in the second state. Of course, the first support plate 22 may be detached from the base plate 11, and only the base plate 11 is retained. In this case, the first support plate 22 is in the third state.

Connection sections 63 are disposed at four corners of each of the first working plate 221 and the second working plate 222. The user may mount the intermediate piece 62 on the connection section 63 and then mount the external hanger 61 on the intermediate piece. Accessory recesses are provided around the first working plate 221 and the second working plate 222, and the user may place accessories and the like in the accessory recesses.

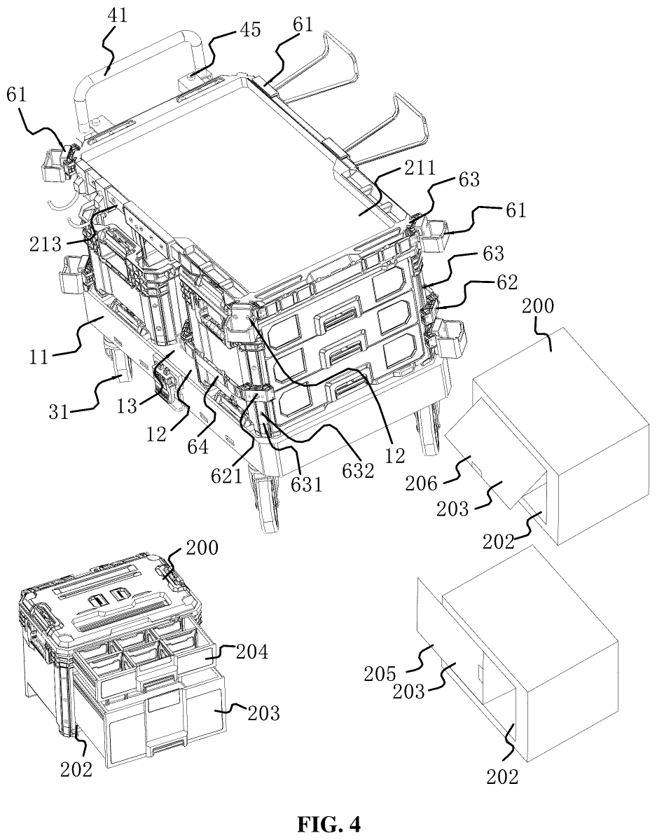

As shown in FIG. 4, in the present application, a sidewall of the storage box 200 may have an opening so that when the user mounts the first support plate 22 on the storage boxes 200 and uses the storage boxes 200 as the support legs between the base plate 11 and the first support plate 22, the user may directly open the sidewall of the storage box 200 when the user needs to take or store an item 300 out of or into the storage box 200, thereby avoiding the case where the user can open the storage box 200 only after the user detaches the first support plate 22 from the storage box 200. At least one cover plate 203 is provided on the sidewall of the storage box 200 to open or close an opening 202, and the cover plate 203 may be slidably connected or rotatably connected to a body of the storage box 200. The slidable connection here may refer to sliding backward and forward or sliding leftward and rightward. The cover plate 203 may be a drawer 204, that is, the storage box 200 may be a drawer box, and the user may pull the drawer 204 out to open the opening 202 of the storage box 200. Alternatively, the cover plate 203 is a sliding door 205 that can be slid leftward and rightward by the user. The user moves the sliding door 205 leftward or rightward to open the opening 202 of the storage box 200. Similarly, the user moves the sliding door 205 leftward or rightward to close the storage box 200. Alternatively, the cover plate 203 may be a flipping plate 206, and the flipping plate 206 may be flipped up and down or flipped left and right relative to the body of the storage box 200 so that if the user wants to open the storage box 200, the user simply rotates the flipping plate 206 to expose the opening 202. The sidewall here refers to a left sidewall, a right sidewall, a front sidewall, and a rear sidewall that form the perimeter of the storage box 200. Additionally, the storage box 200 may be provided with multiple cover plates 203 so that the inside of the storage box 200 is divided into multiple storage spaces, facilitating the storage and management by the user.

As shown in FIG. 3, as a feasible example, the walking assembly 30 further includes an intermediate rod configured to connect two wheels 31. That is to say, the cart 100 includes at least two intermediate rods, which are a first intermediate rod 32 and a second intermediate rod 33, respectively. One intermediate rod connects two wheels 31. The intermediate rod can rotate relative to the base plate 11, and during rotation, the intermediate rod can drive the wheels 31 to rotate together. The base plate 11 is recessed upward from the bottom to form the lower recess 14, the intermediate rod is at least partially accommodated in the lower recess 14, and the wheels 31 can rotate along with the intermediate rod into the lower recess 14 during rotation with the intermediate rod. That is to say, the wheels 31 can be completely stored in the lower recess 14. Thus, when the cart 100 is not used, the user can store the wheels 31 in the lower recess 14, facilitating storage and transportation. When the user needs to use the walking function of the cart 100, the user flips the wheels 31 out of the lower recess 14. In this example, the wheels 31 are omni wheels so that when the user pushes or pulls the cart 100, the user can conveniently adjust a direction of the cart 100, facilitating the use of the user. The wheels 31 may be configured with a foot brake.

The cart 100 further includes a locking device 34 capable of mating with the walking assembly 30. Specifically, the locking device 34 is configured to lock the intermediate rod s so that the wheels 31 can remain in the current state, avoiding state switching due to vibration of the cart 100 during transportation or use. The locking device 34 includes a first lever 341, a second lever 342, an elastic member 343, a first adaption portion 321 and a second adaption portion 322 capable of mating with the first lever 341, a third adaption portion 331 and a fourth adaption portion 332 capable of mating with the second lever 342, and a housing 344. The housing 344 is mounted to the lower end of the base plate 11. In other words, the housing 344 is disposed in the lower recess 14. The first lever 341 and the second lever 342 are at least partially disposed in the housing 344, the elastic member 343 is disposed in the housing 344, one end of the elastic member 343 is connected to the first lever 341, and the other end of the elastic member 343 is connected to the second lever. The first adaption portion 321 and the second adaption portion 322 are disposed on the first intermediate rod 32, and the third adaption portion 331 and the fourth adaption portion 332 are disposed on the second intermediate rod 33. The first lever 341 is formed with a first operating portion 347 operable by the user and a first engaging portion 345 capable of mating with the first adaption portion 321 or the second adaption portion 322. The second lever 342 is formed with a second operating portion 348 operable by the user and a second engaging portion 346 capable of mating with the third adaption portion 331 or the fourth adaption portion 332. When the wheels 31 are in the folded state, the first engaging portion 345 is engaged with the first adaption portion 321, and the second engaging portion 346 is engaged with the third adaption portion 331. When the user wants to switch the wheels 31 from the folded state to the unfolded state, the first operating portion 347 and the second operating portion 348 need to be toggled. The first operating portion 347 and the second operating portion 348 are moved towards each other so that the first engaging portion 345 is released from the first adaption portion 321, and the second engaging portion 346 is released from the third adaption portion 331. In this process, the first lever 341 and the second lever 342 press against the elastic member 343. The wheels 31 are rotated until the first engaging portion 345 and the second engaging portion 346 are engaged with the second adaption portion 322 and the fourth adaption portion 332 under the action of the elastic member 343 to keep the wheels 31 in the unfolded state. When the user needs to switch the wheels 31 from the unfolded state to the folded state, the user also toggles the first operating portion 347 and the second operating portion 348 towards each other and then flips the wheels 31 inward until the first engaging portion 345 is engaged with the first adaption portion 321, and the second engaging portion 346 is engaged with the third adaption portion 331.

The first adaption portion 321 and the second adaption portion 322 are specifically two holes formed on the first intermediate rod 32. Similarly, the third adaption portion 331 and the fourth adaption portion 332 are two holes formed on the second intermediate rod 33. The first lever 341 and the second lever 342 are elongated columns and can be inserted into corresponding holes.

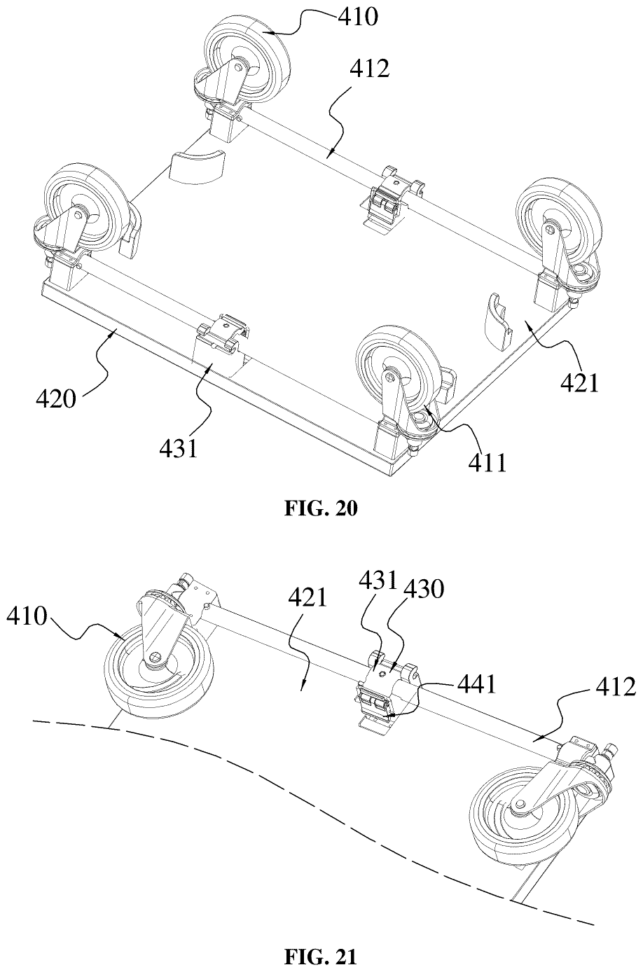

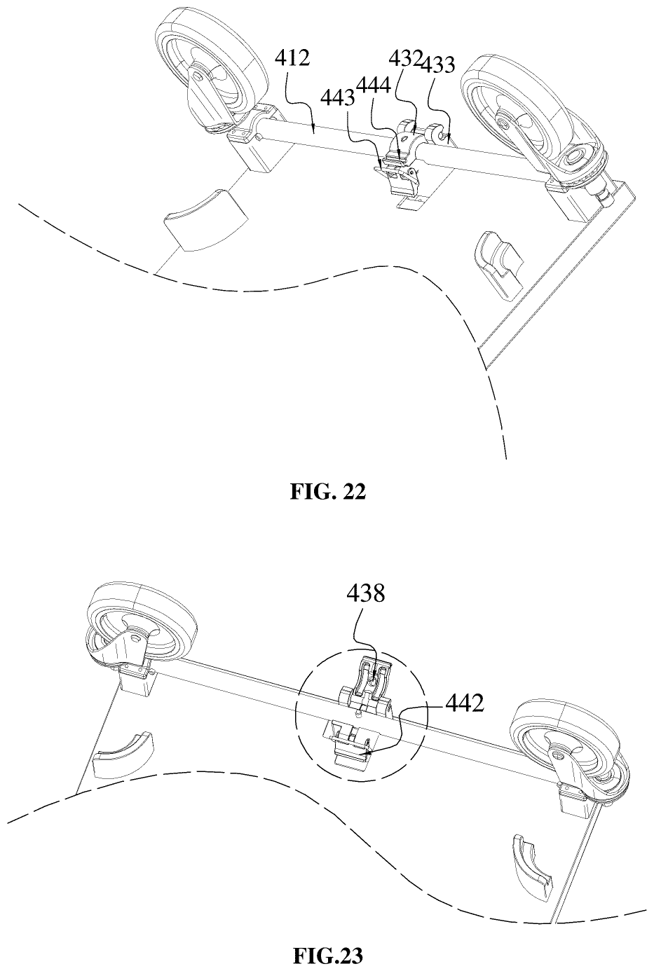

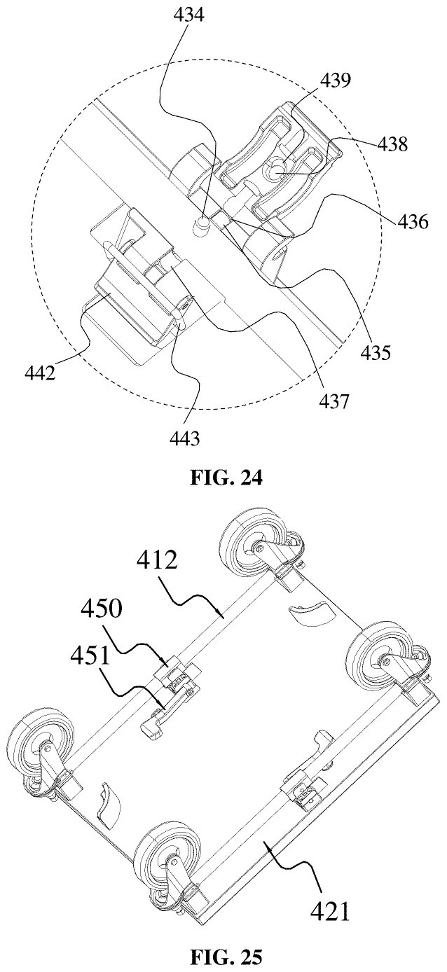

As another specific example of the locking device, as shown in FIGS. 20 to 25, the base plate, the wheels, and the intermediate rods have substantially the same structures as those in the preceding example, and only differences are described below.

As shown in FIGS. 20 to 24, a locking device 430 is configured to control wheels 411 to switch between a traveling state and a folded state, the locking device 430 is at least partially disposed at the lower end of a base plate 421, and the locking device 430 includes a limiting assembly 431 and a locking assembly 441, where the limiting assembly 431 is configured to mate with an intermediate rod 412 to prevent rotation of the intermediate rod 412, and the locking assembly 441 mates with the limiting assembly 431 to fix the intermediate rod 412 in the current state. Under some working conditions, the user needs to use the cart 100 to transport tools from a storage place to a workplace. To reduce the number of times the tools are transported, the user stacks all the tools required for working on the cart 100 as much as possible, resulting in a very heavy load on the cart 100. Moreover, the workplace of the user inevitably has some places with relatively complicated road conditions. A relatively large weight of the cart 100 and uneven roads lead to strong vibrations when the user pushes the cart 100. The wheels 411 tend to be out of the traveling state due to a failure of the wheels 411 to withstand such strong vibrations, and thus the cart 100 cannot be used. The limiting assembly 431 and the locking assembly 441 are disposed so that the wheels 411 can always remain in the traveling state.

The limiting assembly 431 includes an adapter 432 and a base 33, the base 33 is connected to or integrally formed with the base plate 421, and the adapter 432 is connected to the base 33 and rotatable relative to the base 33. In this example, the base 33 is connected to the base plate 421, one end of the adapter 432 is connected to the base 33, the other end of the adapter 432 can be driven to move freely, and the other end of the adapter 432 can be connected to the base 33 during movement. The intermediate rod 412 is at least partially in contact with the base 33, and the intermediate rod 412 is rotatable relative to the base 33. The adapter 432 can be driven to switch between a first state and a second state. When the adapter 432 is in the first state, the adapter 432 is connected to the base 33, and the intermediate rod 412 can only remain at the current position and cannot be rotated, that is, when the adapter 432 is at a first position, the adapter 432 and the base 33 prevent the rotation of the intermediate rod 412. When the adapter 432 is in the second state, only one end of the adapter 432 is connected to the base 33, and the intermediate rod 412 can be driven to rotate relative to the base 33. The locking assembly 441 can mate with the limiting assembly 431 so that the other end of the adapter 432 can be connected to the base 33.

As a feasible example, the locking assembly 441 includes a cam 442 and a clasp 443, where the cam 442 is rotatably connected to the base 33, the clasp 443 is connected to the cam 442, and the clasp 443 mates with the cam 442 so that one end of the adapter 432 can be connected to the base 33. One end of the adapter 432 is provided with an engaging portion 444 mating with the clasp 443. The clasp 443 has a locking state and a release state relative to the adapter 432. When the clasp 443 is in the locking state, the clasp 443 is connected to the adapter 432, and the clasp 443 applies a force to the adapter 432 and the base 33 so that the adapter 432 and the base 33 remain relatively fixed, the adapter 432 and the base 33 lock the intermediate rod 412, and the intermediate rod 412 cannot rotate since the adapter 432 and the base 33 abut against the intermediate rod 412. When the clasp 443 is in the release state, the clasp 443 is separated from the adapter 432, and the adapter 432 is allowed to be separated from the base 33.

When the user wants to switch the clasp 443 from the locking state to the release state, the cam 442 is driven to rotate upward. During upward rotation of the cam 442, the clasp 443 is driven to move upward, and the force applied to the adapter 432 and the base 33 disappears. Then, the clasp 443 is driven to rotate so that the clasp 443 is separated from the engaging portion 444. At this time, the clasp 443 is switched from the locking state to the release state. After the clasp 443 is separated from the adapter 432, the adapter 432 can be driven to rotate relative to the base 33, and the user can drive the intermediate rod 412 to rotate relative to the base 33. When the user wants to switch the clasp 443 from the release state to the locking state, the clasp 443 is driven to move upward to be in contact with the engaging portion 444, and the clasp 443 is partially sleeved on the adapter 432. Since the clasp 443 is connected to the cam 442, when the clasp 443 is moved upward, the cam 442 is also rotated upward until the clasp 443 is in contact with the engaging portion 444. The cam 442 is driven to rotate downward, and the clasp 443 is driven to move downward until the adapter 432 and the base 33 abut against the intermediate rod 412. At this time, the clasp 443 is in the locking state. When the clasp 443 is in the locking state, the wheels 411 may be in the traveling state or the folded state.

As a feasible example, the limiting assembly 431 further includes a positioning pin, the positioning pin is connected to the intermediate rod 412, and the positioning pin abuts against the adapter 432 after the adapter 432 is rotated by a preset angle. When the positioning pin abuts against the adapter 432, the intermediate rod 412 can only remain in the current state so that the wheels 411 remain in the current state, that is, the wheels 411 remain in the traveling state or the folded state.

Specifically, the limiting assembly 431 includes two positioning pins, which are defined as a first positioning pin 434 and a second positioning pin 435, respectively. The first positioning pin 434 and the second positioning pin 435 are arranged in a circumferential direction of the intermediate rod 412, the first positioning pin 434 and the second positioning pin 435 each penetrate the intermediate rod 412, and one end of the first positioning pin 434 and one end of the second positioning pin 435 each protrude out of the intermediate rod 412. When the wheels 411 are in the traveling state, the first positioning pin 434 abuts against the adapter 432. When the wheels 411 are in the folded state, the second positioning pin 435 abuts against the adapter 432. The positioning pin is disposed on the intermediate rod 412 so that the wheels 411 are prevented from rotation in the traveling state, and the wheels 411 always remain in the current state.

The adapter 432 is formed with an adaption portion 438 mating with the positioning pin. When the positioning pin is in contact with the adaption portion 438, the wheels 411 remain in the current state. When the adaption portion 438 mates with the first positioning pin 434, the wheels 411 are in the traveling state. When the adaption portion 438 mates with the second positioning pin 435, the wheels 411 are in the folded state. The base 33 is formed with a first stop portion 436 and a second stop portion 437 which mate with the positioning pins. The first stop portion 436 and the second stop portion 437 are disposed at two ends of the base 33 one to one. It is to be understood that the first stop portion 436 and the second stop portion 437 are disposed on two sides of the intermediate rod 412. When the wheels 411 are in the traveling state, the first positioning pin 434 is in contact with the adaption portion 438, and the second positioning pin 435 is in contact with the first stop portion 436. When the wheels 411 are in the folded state, the first positioning pin 434 is in contact with the second stop portion 437, and the second positioning pin 435 is in contact with the adaption portion 438. Thus, when the wheels 411 are in the traveling state, the positioning pin mates with the base 33 and the adapter 432 to prevent the rotation of the intermediate rod 412.

The adapter 432 further includes a guide portion 439 configured to guide the positioning pin to slide into the adaption portion 438. The guide portion 439 is connected to and integrally formed with the adaption portion 438. The adaption portion 438 is specifically a hole formed in the adapter 432, and the guide portion 439 is an inclined arc-shaped surface. Thus, when the intermediate rod 412 is rotated to a corresponding position, the positioning pin is first in contact with the guide portion 439, and the adapter 432 is rotated with the guide portion 439 adjusting a position of the positioning pin until the positioning pin is inserted into the adaption portion 438 under the guide of the guide portion 439.

As a method of use, when the user wants to switch the wheels 411 from the folded state to the traveling state, the clasp 443 is in the locking state, the first positioning pin 434 is in contact with the second stop portion 437, the second positioning pin 435 is in contact with the adaption portion 438, and the adapter 432 is in the first state. The user operates the cam 442 for upward rotation to cancel the force applied by the clasp 443 to the adapter 432 and the base 33. The user rotates the clasp 443 to separate the clasp 443 from the engaging portion 444, and at this time, the adapter 432 is still in the first state. The user rotates the adapter 432 to switch the adapter 432 from the first state to the second state so that the adaption portion 438 is separated from the second positioning pin 435. The user rotates the intermediate rod 412 to separate the first positioning pin 434 from the second stop portion 437. The user continues to rotate the intermediate rod 412 until the first stop portion 436 is in contact with the second positioning pin 435. The user rotates the adapter 432 to make the guide portion 439 on the adapter 432 in contact with the first positioning pin 434. The user continues to rotate the adapter 432 so that the first positioning pin 434 is inserted into the adaption portion 438, and the adapter 432 is in the first state. The user rotates the clasp 443 so that the clasp 443 is sleeved on the engaging portion 444 and then rotates the cam downward so that the cam drives the clasp 443 to move downward until the clasp is in the locking state. The clasp 443 applies a force to the adapter 432 and the base 33, so as to reduce interspace between contact portions of the base 33, the adapter 432, and the intermediate rod 412. Thus, it is ensured that during use of the cart 100, the wheels 411 can always remain in the traveling state and are prevented from switching from the traveling state to the folded state due to the vibrations of the cart 100, and the structural stability of the cart 100 is ensured.

Of course, to ensure the structural stability, another locking device 430 is disposed symmetrically on the other intermediate rod 412, which has substantially the same structure and principle, and the details are not repeated here.

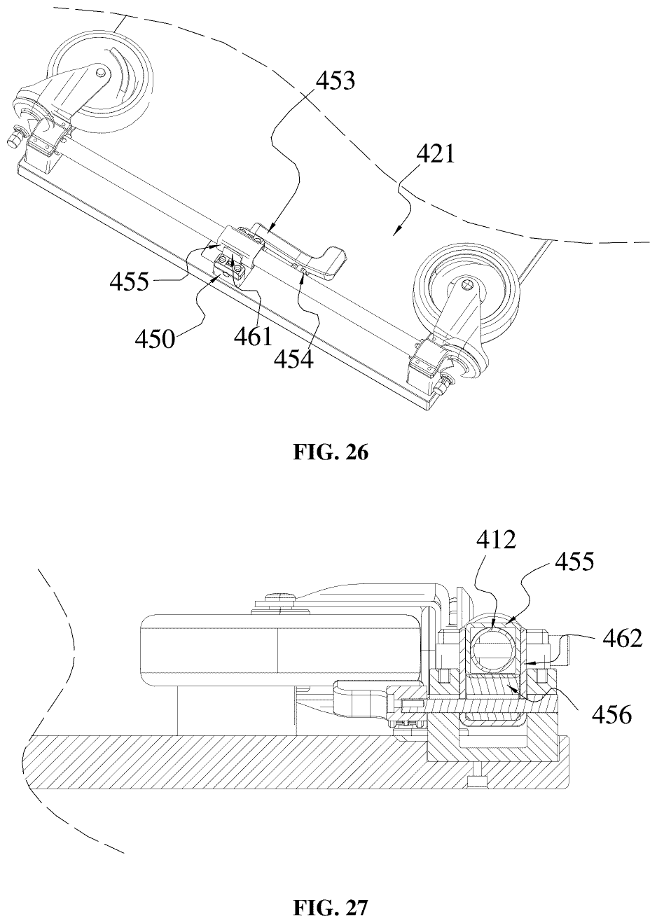

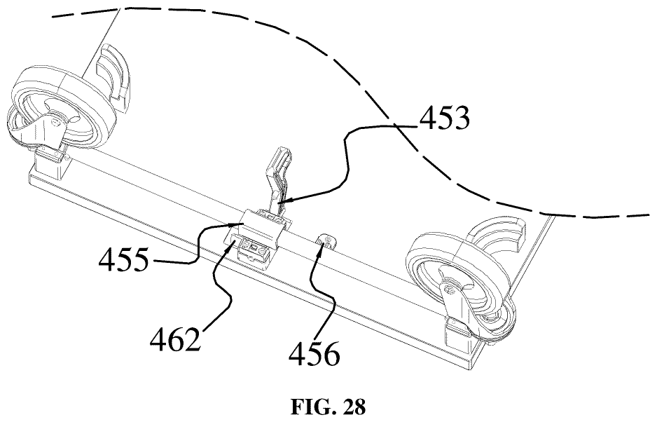

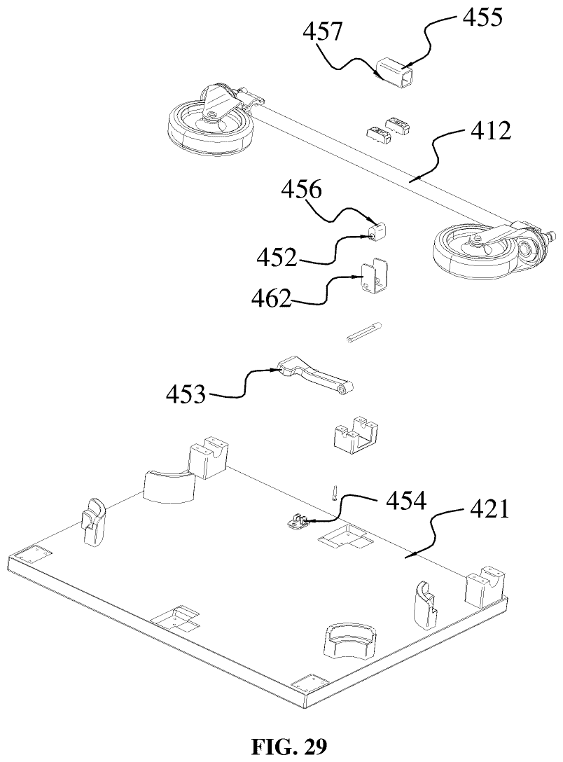

As another specific example of the locking device, as shown in FIGS. 25 to 29, the base plate 421, the wheels 411, and the intermediate rod 412 are substantially the same as those in the preceding example and use the same reference numerals as those in the preceding example.

A locking device 450 is configured to control the wheels 411 to switch between the traveling state and the folded state, the locking device 450 is at least partially disposed at the lower end of the base plate 421, and the locking device 450 includes a locking assembly 451 mating with the intermediate rod 412 to maintain the intermediate rod 412 in the traveling state.

The locking assembly 451 includes an abutting member 452, a handle 453, and a clip 454. The abutting member 452 can be driven to rotate. During rotation of the abutting member 452, the abutting member 452 can mate with the intermediate rod 412. The handle 453 can be driven by the user, and the handle 453 is connected to the abutting member 452, that is, the abutting member 452 can rotate along with the handle 453. The clip 454 is connected to the base plate 421, and the clip 454 is configured to mate with the handle 453 to maintain the handle 453 at the current position. When the clip 454 is separated from the handle 453, the handle 453 can drive the abutting member 452 to rotate.

Additionally, the locking assembly 451 further includes a base, a positioning member 455, and a connection pin, the base is connected to the base plate 421, and the handle 453 and the abutting member 452 are connected to the base through the connection pin so that the handle 453, the connection pin, and the abutting member 452 can rotate synchronously. The positioning member 455 can mate with the abutting member 452 to maintain the intermediate rod 412 at the current position, the positioning member 455 is sleeved on the outer perimeter of the intermediate rod, and the positioning member 455 rotates together with the intermediate rod 412. The positioning member 455 is formed with an adaption portion 457, and the abutting member 452is formed with a cam portion 456. During rotation of the abutting member 452, the cam portion 456 is in an interference fit with the adaption portion 457. When the cam portion 456 abuts against the adaption portion 457, the wheels 411 remain in the current state. When the cam portion 456 is separated from the adaption portion 457, the intermediate rod 412 can be driven to rotate.

A cross-section of the positioning member 455 is substantially rectangular. As an example, the positioning member 455 and the intermediate rod 412 are two parts and are mounted to rotate synchronously. As another example, the positioning member 455 and the intermediate rod 412 are integrally formed, that is, a cross-section of the intermediate rod 412 is substantially rectangular. The cam portion 456 is substantially arc-shaped so that when the cam portion 456 abuts against the adapter, an interference area between the abutting member and the positioning member 455 is relatively large, and the structure between the abutting member 452 and the positioning member 455 is more stable.

The locking device 450 further includes a limiting assembly 461 configured to guide the positioning member 455 to rotate to a preset position, thereby facilitating the interference between the abutting member 452 and the positioning member 455. The limiting assembly 461 is connected to the base and can be driven to rotate together with the abutting member 452. The limiting assembly 461 includes a guide member 462 connected to the connection pin and rotating together with the abutting member 452. When the wheels 411 are in the traveling state, the guide member 462 is at least partially in contact with the positioning member 455. Further, when the wheels 411 are in the traveling state, the guide member 462 at least partially overlaps the abutting member 452 in a direction perpendicular to an extension direction of the intermediate rod 412. The guide member 462 is substantially U-shaped. When the wheels 411 are in the traveling state, the positioning member 455 is at least partially disposed between the guide member 462, and the abutting member 452 is located at the lower end of the positioning member 455. That is to say, during rotation, the guide member 462 is in contact with the positioning member 455 prior to the abutting member 452. During rotation of the guide member 462, the guide member 462 is first in contact with the positioning member 455 and guides the positioning member 455 to the preset position, facilitating an interference fit between the abutting member 452 and the positioning member 455.

As a method of use, when the user wants to switch the wheels 411 from the folded state to the traveling state, the handle 453 is engaged with the clip 454, the guide member 462 is at least partially in contact with the positioning member 455, and the abutting member 452 is in the interference fit with the positioning member 455. The user operates the handle 453 to separate the handle 453 from the clip 454 and continues to rotate the handle 453 upward to drive the guide member 462 and the abutting member 452 to rotate downward together so that the abutting member 452 is separated from the positioning member 455, and the guide member 462 is separated from the positioning member 455. The intermediate rod 412 is driven to rotate to the preset position, that is, the wheels 411 are flipped out from the lower end of the base plate 421. Then, the handle 453 is rotated reversely, that is, the handle 453 is rotated downward to drive the guide member 462 and the abutting member 452 to rotate upward together until the guide member 462 is at least partially in contact with the positioning member 455. The handle 453 continues to be rotated downward until the handle 453 is engaged with the clip 454. At this time, the abutting member 452 abuts against the positioning member 455 in an interference fit.

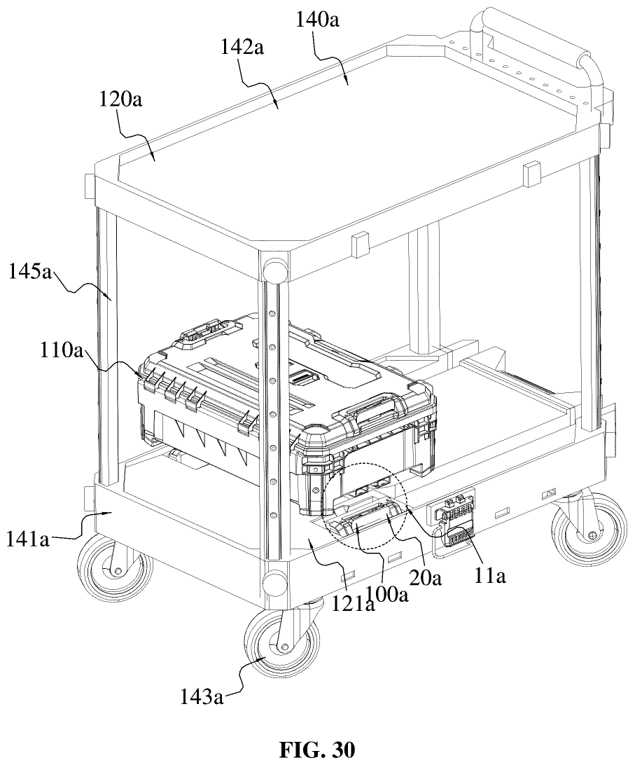

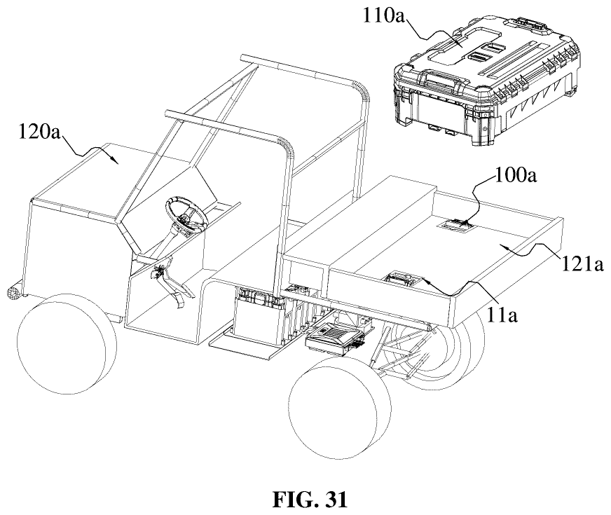

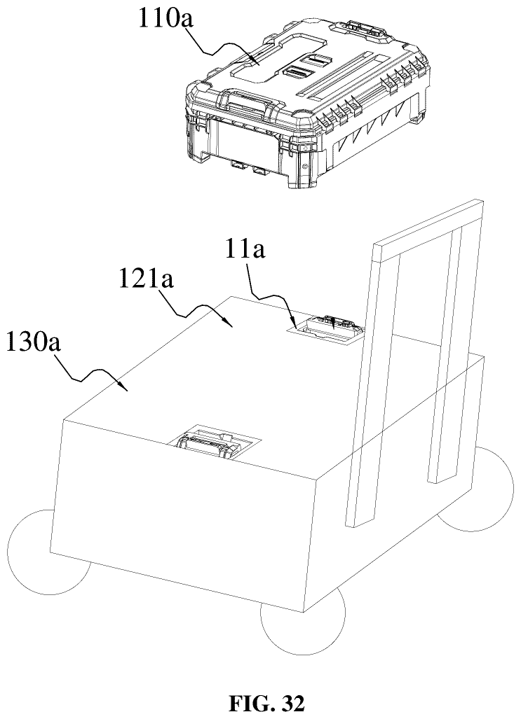

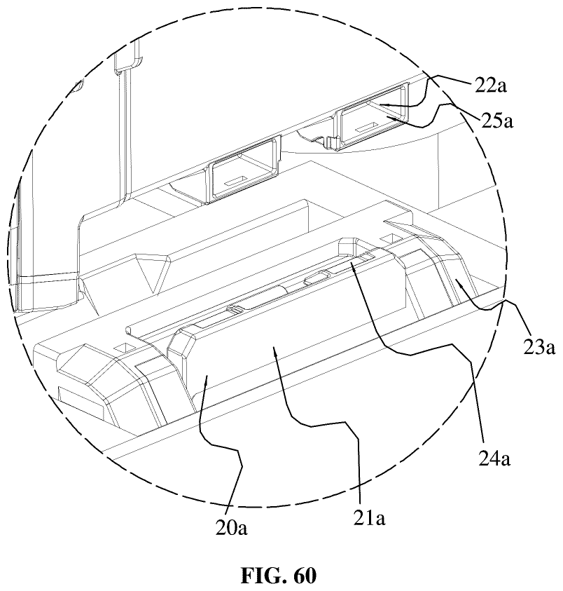

As shown in FIGS. 30 to 33 and FIG. 60, connecting devices 100a are shown. The connecting device 100a can mount a to-be-mounted part 110a to a tool 120a or a toolbox 130a, the to-be-mounted part 110a may be a toolbox for accommodating an item, the tool 120a may be a cart 140a as shown in the FIG. 30, or a utility terrain vehicle as shown in the FIG. 31. The connecting device 100a includes a base 10a and a connecting assembly 20a. An accommodation cavity 17a is formed in the base 10a. The connecting assembly 20a can be at least partially located in the accommodation cavity 17a. The connecting assembly 20a is configured to be connected to the to-be-mounted part 110a. The connecting assembly 20a can move relative to the base 10a, and the movement here includes one or a combination of rotation, movement, and disassembly. The base 10a is formed on or connected to the tool 120a or the toolbox 130a. It is to be noted that the rotation here includes flipping, folding, rotation, and the like. Similarly, the movement here includes curved movement, linear movement, reciprocating movement, and the like.

The connecting assembly 20a moves relative to the base 10a. During the movement of the connecting assembly 20a, the connecting assembly 20a has at least a connection state and a hidden state relative to the base 10a. When the connecting assembly 20a is in the connection state, a connector 21a of the connecting assembly 20a is at a mating position so that the connector 21a can mate with the to-be-mounted part 110a. It may also be understood as that when the connecting assembly 20a is at the mating position, the to-be-mounted part 110a can be connected to the tool 120a or the toolbox 130a. When the connecting assembly 20a is in the hidden state, the connector 21a is at a hidden position so that the connector 21a is separated from the mating position. It may also be understood as that when the connecting assembly 20a is at the hidden position, the to-be-mounted part 110a cannot be connected to the tool 120a or the toolbox 130a. However, the to-be-mounted part can be directly stacked on the connecting assembly 20a.

The to-be-mounted part here includes, but is not limited to, a table tool, a charging device, a power supply device, an illumination device, a refrigeration device, a heating device, a blowing device, a toolbox, a screen display assembly, and other items. The tool here may be a direct current (DC) tool or an alternating current (AC) tool, including, but not limited to, a UTV, a riding mower, an electric vehicle, or an electric motorcycle. The tool may also be a tool driven by a mixture of hydrocarbon substances such as diesel, gasoline, or kerosene, including, but not limited to, a tractor or the like. The tool may also be a non-energy-driven tool, including, but not limited to, a bicycle, a cart 140a, a trailer, a fixed workbench, a storage rack, or the like. The toolbox includes, but is not limited to, a hand-pushed toolbox, a self-propelled toolbox, a foldable tool, a common toolbox for storing the power tool, a crate, a drawer box, or the like. In other words, it is sufficient as long as the connecting device can be mounted on the tool or the to-be-mounted part.

The connecting device 100a is configured in this manner so that when the user needs to use the connecting function, the connecting assembly 20a is in the connection state; and when the user does not need to use the connecting function, the connecting assembly 20a is in the hidden state. Therefore, the connecting assembly 20a can be protected and the user's selection is facilitated. As a feasible example, when the connecting assembly 20a is in the hidden state, the connector 21a is lower than an upper surface 11a of the base 10a or lower than a storage surface 121a of the tool 120a or the toolbox 130a. It is to be understood that the connecting assembly 20a has at least two states relative to the base 10a, namely the connection state and the hidden state. When the connecting assembly 20a is in the connection state, the connector 21a at least partially protrudes from the upper surface 11a of the base 10a or the storage surface 121a of the tool 120a or the toolbox 130a, and the connector 21a may be connected to the to-be-mounted part 110a. When the connecting assembly 20a is in the hidden state, the connector is lower than the upper surface 11a of the base 10a or lower than the storage surface 121a of the tool 120a or the toolbox 130a. Further, when the connecting assembly 20a is in the hidden state, the connecting assembly 20a is lower than the upper surface 11a of the base 10a or lower than the storage surface 121a of the tool 120a or the toolbox 130a. Of course, when the connecting assembly 20a is in the hidden state, the connecting assembly 20a may be flush with the upper surface 11a of the base 10a, or the connecting assembly 20a may be flush with the storage surface 121a of the tool 120a or the toolbox 130a. It is to be noted that, in some feasible examples, when the connecting assembly 20a is in the hidden state, that is, the connector 21a is lower than the upper surface 11a of the base 10a or lower than the storage surface 121a of the tool 120a or the toolbox 130a, the to-be-mounted part 110a may be connected to the connector 21a. When the base 10a is formed on the tool 120a or the toolbox 130a or is detachably connected to the tool 120a or the toolbox 130a, the upper surface 11a of the base 10a is lower than the storage surface 121a of the tool 120a or the toolbox 130a. Items can be directly placed on the storage surface 121a of the tool 120a or the toolbox 130a, or the storage surface 121a of the tool 120a or the toolbox 130a is used as a workbench. When the connecting assembly 20a is in the hidden state, the connecting assembly 20a is configured to be lower than the upper surface 11a of the base 10a or lower than the storage surface 121a of the tool 120a or the toolbox 130a. In this manner, when the user places items or performs other operations on the storage surface 121a of the tool 120a or the toolbox 130a, the connecting assembly 20a does not cause any obstruction. Moreover, the connecting assembly 20a can be prevented from being damaged when the user stacks items or performs other operations, thereby further extending the service life of the connecting assembly 20a.

To clearly describe the technical solution of the present application and the effect brought about by the connecting device 100a, a cart 140a is used as an example here. But the tool is not limited to the cart 140a and may also be another tool 120a. Similarly, the case where the to-be-mounted part 110a is the toolbox 130a is used as an example, and the to-be-mounted part 110a is not limited to the toolbox 130a and may also be another item mentioned above.

FIG. 30 shows the cart 140a applicable to the transportation and placement of the toolbox (to-be-mounted part 110a). From the viewpoint of working conditions, the user generally needs to carry to-be-used tools when going to a workplace, such as power tools, tape measures, accessories, etc. To make it convenient for the user to carry and transport the tool, the user generally stores the tool in the toolbox. The user may place, hang, or fix the toolbox or the tool on the cart 140a so that the user can use the cart 140a to transport the toolbox or the tool.

The cart 140a includes a first support plate 141a, a second support plate 142a, a traveling assembly 143a, and a support assembly 145a. The first support plate 141a and the second support plate 142a are spaced apart, the second support plate 142a is disposed on the upper side of the first support plate 141a, the traveling assembly 143a is connected to the lower side of the first support plate 141a, and the support assembly 145a connects the first support plate 141a to the second support plate 142a.

The connecting device 100a is mounted on the first support plate 141a and/or the second support plate 142a. As an example, the base 10a is formed on the first support plate 141a and/or the second support plate 142a. As another example, the base 10a is detachably connected to the first support plate 141a and/or the second support plate 142a, that is, the base 10a may be connected to the first support plate 141a and/or the second support plate 142a through one or a combination of screws, rivets, interference fit, clamping, and mortise and tenon joints. The connection manner between the base 10a and the first support plate 141a and/or the second support plate 142a is not limited here, as long as the base 10a can be fixedly connected to the first support plate 141a and/or the second support plate 142a.

As an example, the base 10a is directly formed on the first support plate 141a. Of course, for the connection stability, multiple connecting devices 100a may be disposed on the first support plate 141a. When the user needs to connect the toolbox to the first support plate 141a, the connecting assembly 20a is switched to the connection state to fix the toolbox to the first support plate 141a. When the user does not need to connect the toolbox to the first support plate 141a, the connecting assembly 20a is switched to the hidden state. In this manner, the user can stack other tools on the first support plate 141a without worrying that other tools damage the connecting assembly 20a during transportation or handling. That is to say, in this case, no other protruding structures exist on the first support plate 141a, and the user may switch the first support plate 141a into a flat plate and directly stack some to-be-mounted parts on the flat plate.

To more stably mount the toolbox onto the first support plate 141a, the connecting devices 100a are disposed on two opposite sides of the first support plate 141a. Of course, if the length of the first support plate 141a is sufficient, multiple pairs of oppositely arranged connecting devices 100a may be disposed on the first support plate 141a, thereby mounting the toolbox or other items.

As an example, the connecting assembly 20a includes the connector 21a, positioning members 22a, and a connecting base 23a. The positioning members 22a are fixedly connected to or integrally formed with the toolbox, the connecting base 23a is mounted on the base 10a, and the connecting base 23a is fixedly connected to the base 10a. Of course, since the base 10a is directly formed on the first support plate 141a, it may also be understood as that the connecting base 23a is fixedly connected to the first support plate 141a. The connector 21a is disposed in the connecting base 23a. The connector 21a is movable relative to the connecting base 23a. The connector 21a has at least a separation position and an interlocked position relative to the connecting base 23a. When the connector 21a is at the separation position, the positioning members 22a and the connector 21a are separated. When the connector 21a is at the interlocked position, the connector 21a and the positioning members 22a are interlocked. The connector 21a can be driven to switch between the separation position and the interlocked position. For example, the connector 21a has buckles 24a, and the positioning members 22a have grooves 25a. When the user needs to connect the toolbox to the first support plate 141a, the user only needs to snap the buckles 24a into the grooves 25a. When the user needs to remove the toolbox from the first support plate 141a, the user only needs to detach the buckles 24a from the grooves 25a. When the connecting assembly 20a is in the connection state, the buckles 24a are higher than the upper surface 11a of the base along the up and down direction. Of course, other structures may also be adopted. The connection manner between the connector 21a and the toolbox is not limited here, as long as the connection and separation between the toolbox and the connecting assembly 20a can be achieved.

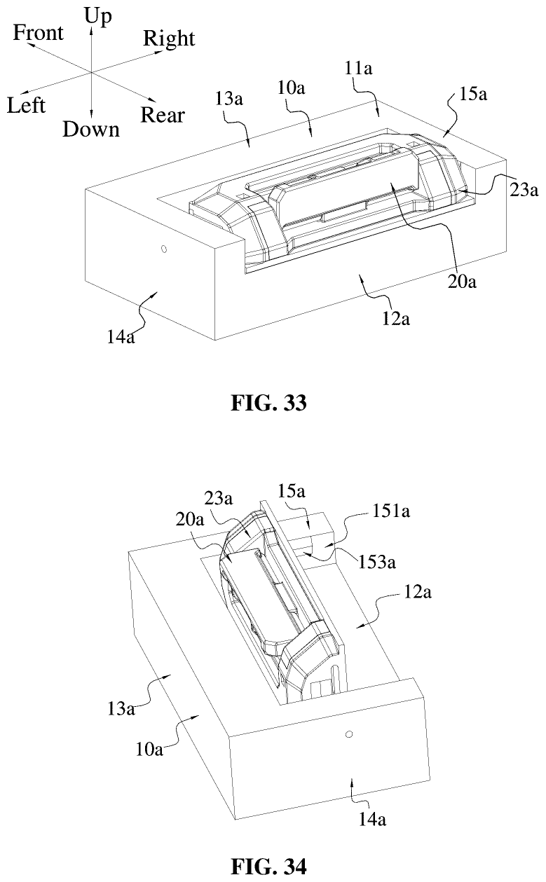

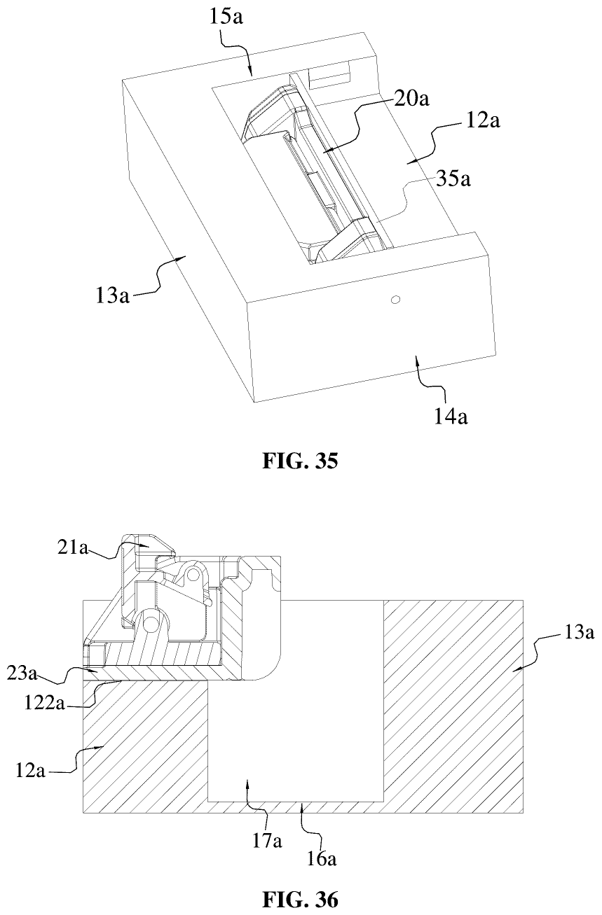

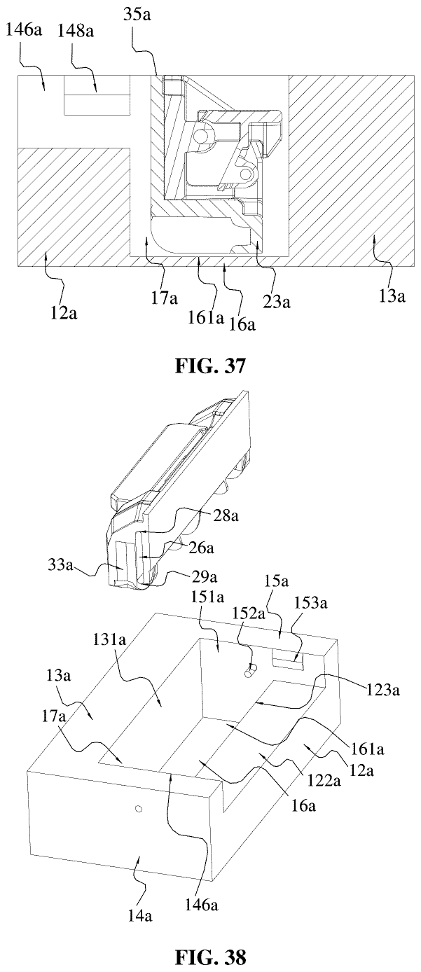

FIGS. 33 to 38 show an example in which the connecting assembly 20a is switched from the connection state to the hidden state relative to the base 10a.

To clearly illustrate the technical solutions in this example, up, down, front, rear, left, and right are defined as shown in FIG. 33. It is to be noted that, unless otherwise specified, up and down, front and rear, and left and right are described below with respect to a stationary state of the connecting device shown in FIG. 33.

When the user needs to switch the connecting assembly 20a from the connection state to the hidden state, the user may fold the connecting assembly 20a upward and then slide the connecting assembly 20a downward until the connecting assembly 20a is in the accommodation cavity 17a.

For example, the base 10a includes a first connecting plate 12a, a second connecting plate 13a, a third connecting plate 14a, a fourth connecting plate 15a, and a fifth connecting plate 16a. The first connecting plate 12a and the second connecting plate 13a are spaced apart. The third connecting plate 14a and the fourth connecting plate 15a are spaced apart. The fifth connecting plate 16a is connected to the first connecting plate 12a, the second connecting plate 13a, the third connecting plate 14a, and the fourth connecting plate 15a. The fifth connecting plate 16a is opposite to the upper surface 11a of the base 10a. The third connecting plate 14a is connected to an end of the first connecting plate 12a and an end of the second connecting plate 13a, and the fourth connecting plate 15a is connected to the other end of the first connecting plate 12a and the other end of the second connecting plate 13a. Along the up and down direction, the length of the first connecting plate 12a is less than the length of the second connecting plate 13a, and the length of the third connecting plate 14a and the length of the fourth connecting plate 15a are each basically the same as the length of the second connecting plate 13a. That is to say, the first connecting plate 12a, the third connecting plate 14a, and the fourth connecting plate 15a basically form a concave shape at the ends. The inner walls of the first connecting plate 12a, the second connecting plate 13a, the third connecting plate 14a, the fourth connecting plate 15a, and the fifth connecting plate 16a basically form a semi-enclosed accommodation cavity 17a with an upward opening, and the connecting assembly 20a can be basically accommodated in the accommodation cavity 17a. The upper end of the first connecting plate 12a has an abutment surface 122a. When the connecting assembly 20a is in the connection state, the abutment surface 122a abuts against the connecting base 23a. In this manner, when the toolbox 130a is mounted to the connecting assembly 20a, the abutment surface 122a can form a stable support for the connecting assembly 20a. Of course, the first connecting plate 12a may also have other structures. For example, the upper surface 11a of the first connecting plate 12a may be partially recessed downward to form the abutment surface 122a. The abutment surface 122a is configured to abut against the connecting base 23a when the connecting assembly 20a is in the connection state. Of course, a portion of the fifth connecting plate 16a may protrude to form the abutment surface 122a, and the abutment surface 122a is configured to abut against the connecting base 23a when the connecting assembly 20a is in the connection state.

The first connecting plate 12a corresponds to a first connecting inner wall 123a, the second connecting plate 13a corresponds to a second connecting inner wall 131a, the third connecting plate 14a corresponds to a third connecting inner wall 146a, the fourth connecting plate 15a corresponds to a fourth connecting inner wall 151a, and the fifth connecting plate 16a corresponds to a fifth connecting inner wall 161a. The base 10a is directly formed on the first support plate 141a of the cart 140a, that is to say, the first connecting plate 12a, the second connecting plate 13a, the third connecting plate 14a, the fourth connecting plate 15a, and the fifth connecting plate 16a are directly formed by the first support plate 141a.

The third connecting inner wall 146a and the fourth connecting inner wall 151a are connected to or formed with corresponding supporting ends with basically the same structures, specifically, a first supporting end and a second supporting end 152a. The first supporting end and the second supporting end 152a both protrude outward. Two sides of the connecting base 23a are connected to the first supporting end and the second supporting end 152a, respectively. For example, long grooves with basically the same structures are each formed on one of the two sides of the connecting base 23a. Specifically, the long grooves are a first groove 26a and a second groove 25a. Two ends of the first groove 26a are arc-shaped, and the arcs on two sides are a first end 28a and a second end 29a. Along the extension direction of the first groove 26a, the first end 28a is on a side closer to the connector 21a. Similarly, two ends of the second groove 25a are also arc-shaped, and the arcs on two sides are a third end and a fourth end. Along the extension direction of the first groove 26a, the third end is on a side closer to the connector 21a. Here, the first groove 26a abuts against the first supporting end, and the second groove 25a abuts against the second supporting end 152a. The connecting assembly 20a is restricted and guided by the first supporting end and the second supporting end 152a so that the connecting assembly 20a can achieve state switching.

The third connecting inner wall 146a and the fourth connecting inner wall 151a are connected to or formed with stop portions with basically the same structures, which are a first stop portion 148a and a second stop portion 153a. Clamping portions are each disposed on one of the two sides of the connecting base 23a, which are a first clamping portion 33a and a second clamping portion. The first stop portion 148a can be adapted to the first clamping portion. Similarly, the second stop portion 153a can be adapted to the second clamping portion. When the first stop portion 148a abuts against the first clamping portion and the second stop portion 153a abuts against the second clamping portion, the connecting assembly 20a is in the connection state. Moreover, the first stop portion 148a and the second stop portion 153a are used for preventing the connecting assembly 20a from moving when no external driving force exists.

The original state of the connecting assembly 20a is defined as the hidden state, in which the connector 21a is in the accommodation cavity 17a, the first end 28a of the first groove 26a abuts against the first supporting end, and the third end of the second groove 25a abuts against the second supporting end 152a. When the user wants to switch the connecting assembly 20a to the connection state, the user needs to lift the connecting assembly 20a upward so that the first end 28a and the first supporting end are separated, and the third end and the second supporting end 152a are separated. The user continues lifting the connecting assembly 20a upward until the first supporting end abuts against the second end 29a and the second supporting end 152a abuts against the fourth end. In this case, the user stops moving the connecting assembly 20a upward. The user flips the connecting assembly 20a outward with the contact part between the first supporting end and the second end 29a as the axis until the first stop portion 148a abuts against the first clamping portion and the second stop portion 153a abuts against the second clamping portion, thereby switching the connecting assembly 20a from the hidden state to the connection state. When the user needs to switch the connecting assembly 20a from the connection state to the hidden state, the user only needs to flip the connecting assembly 20a upward with the preceding contact part as the axis until the extension direction of the second groove 25a is roughly parallel to the up and down direction, and then the external force is removed. In this case, under the action of gravity, the connecting assembly 20a is guided by the first supporting end and the second supporting end 152a to move downward to the hidden state. In this case, the switching is completed.

When the connecting assembly 20a is in the hidden state, the connecting base 23a has at least one upward surface, which is defined as an end surface 35a. Along the up and down direction, the distance between the end surface 35a and the fifth connecting plate 16a is the farthest. The end surface 35a is lower than the surface of the first support plate 141a, that is, lower than the storage surface 121a of the first support plate 141a. In this manner, when the user places items on the first support plate 141a, the connecting assembly 20a does not prevent the user from placing items on the first connecting plate 12a, and the items placed on the first connecting plate 12a do not damage the connecting assembly 20a during transportation or handling. When the user needs to use the connector 21a, the user only needs to switch the connecting assembly 20a to the connection state.

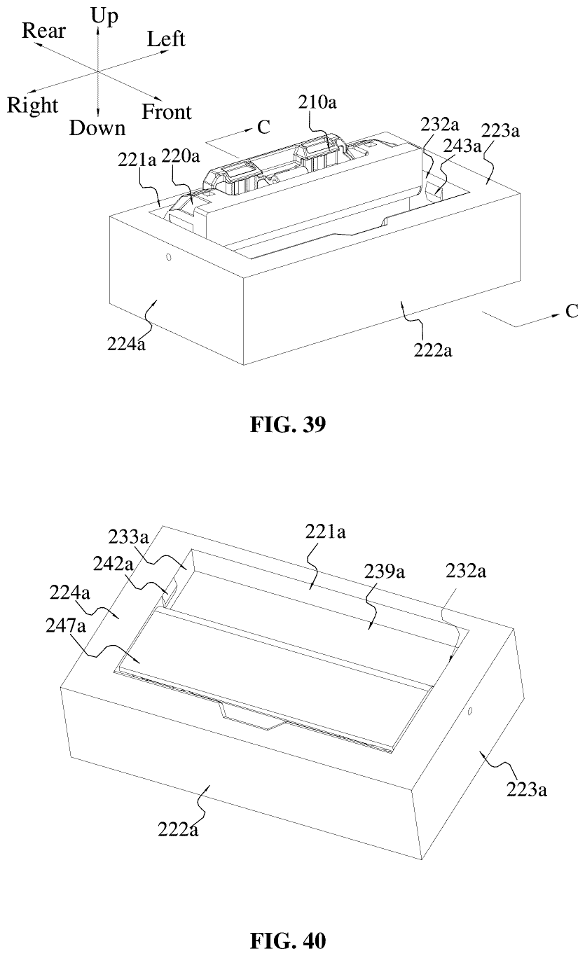

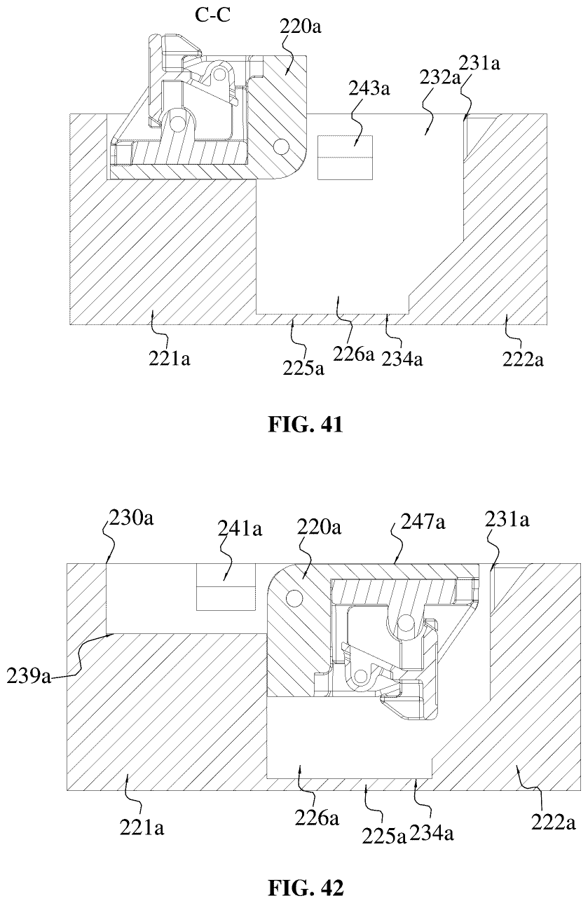

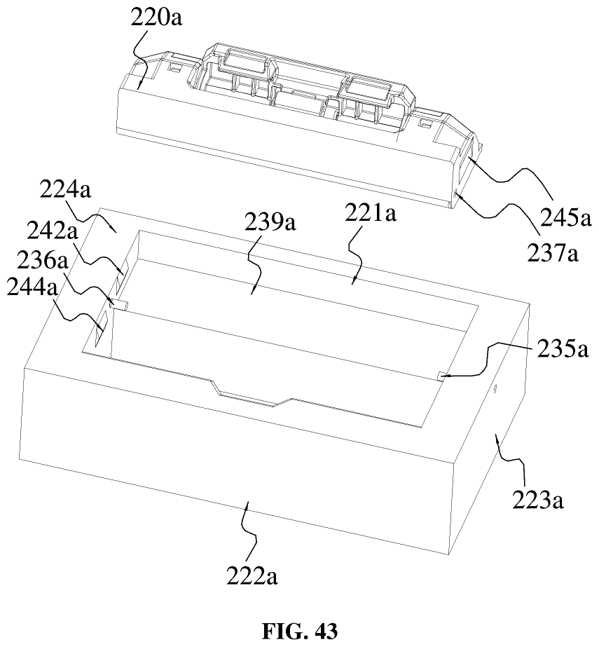

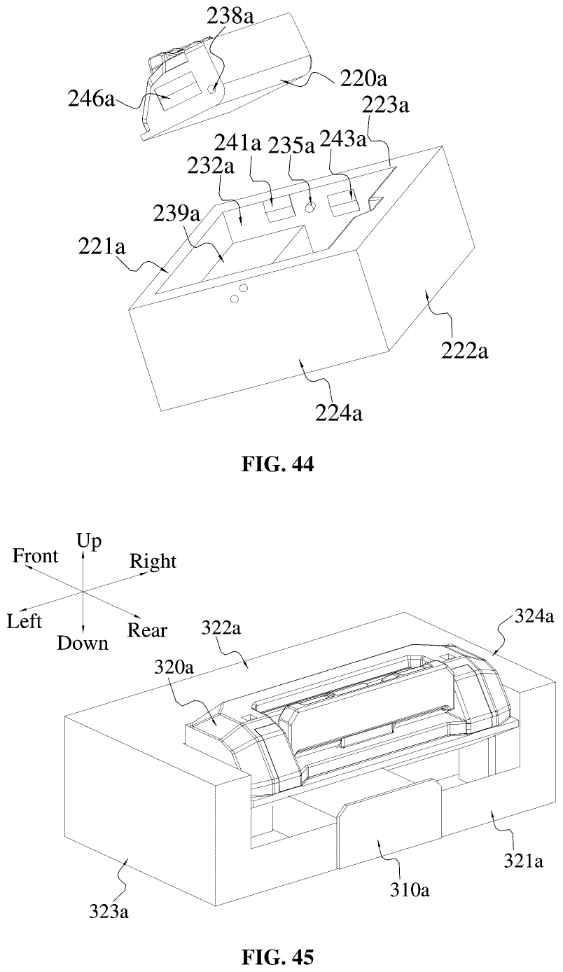

FIGS. 39 to 44 show a second example in which a connecting assembly 210a is switched from the connection state to the hidden state relative to a base 220a. It is to be noted that the differences between example two and example one are the switching manner and the specific connection structure between the connecting assembly 210a and the base 220a. Only the parts of example two which are different from those of example one are introduced here. For other structures, reference may be made to the above.

To clearly illustrate the technical solutions in this example, up, down, front, rear, left, and right are defined as shown in FIG. 39. It is to be noted that, unless otherwise specified, up and down, front and rear, and left and right are described below with respect to a stationary state of the connecting device shown in FIG. 39.

When the user needs to switch the connecting assembly 210a from the connection state to the hidden state, the user may fold the connecting assembly 210a downward until the connecting assembly 210a is in an accommodation cavity 226a.

For example, the base 220a includes a first connecting plate 221a, a second connecting plate 222a, a third connecting plate 223a, a fourth connecting plate 224a, and a fifth connecting plate 225a. The first connecting plate 221a and the second connecting plate 222a are spaced apart. The third connecting plate 223a and the fourth connecting plate 224a are spaced apart. The fifth connecting plate 225a is connected to the first connecting plate 221a, the second connecting plate 222a, the third connecting plate 223a, and the fourth connecting plate 224a. The fifth connecting plate 225a is opposite to the upper surface of the base 220a. The third connecting plate 223a is connected to an end of the first connecting plate 221a and an end of the second connecting plate 222a, and the fourth connecting plate 224a is connected to the other end of the first connecting plate 221a and the other end of the second connecting plate 222a. Along the up and down direction, the length of the first connecting plate 221a is less than the length of the second connecting plate 222a, and the length of the third connecting plate 223a and the length of the fourth connecting plate 224a are each basically the same as the length of the second connecting plate 222a. That is to say, the first connecting plate 221a, the third connecting plate 223a, and the fourth connecting plate 224a basically form a concave shape at the ends. The inner walls of the first connecting plate 221a, the second connecting plate 222a, the third connecting plate 223a, the fourth connecting plate 224a, and the fifth connecting plate 225a basically form a semi-enclosed accommodation cavity 226a with an upward opening, and the connecting assembly 210a can be basically accommodated in the accommodation cavity 226a. The upper surface of the first connecting plate 221a may be partially recessed downward to form an abutment surface, and the abutment surface is configured to abut against the connecting base when the connecting assembly 210a is in the connection state. Of course, the first connecting plate 221a may have other structures. For example, the upper end of the first connecting plate 221a has an abutment surface. When the connecting assembly 210a is in the connection state, the abutment surface abuts against the connecting base. In this manner, when the toolbox is mounted to the connecting assembly 210a, the abutment surface can form a stable support for the connecting assembly 210a. Of course, a portion of the fifth connecting plate 225a may protrude to form the abutment surface, and the abutment surface is configured to abut against the connecting base when the connecting assembly 210a is in the connection state.

The first connecting plate 221a corresponds to a first connecting inner wall 230a, the second connecting plate 222a corresponds to a second connecting inner wall 231a, the third connecting plate 223a corresponds to a third connecting inner wall 232a, the fourth connecting plate 224a corresponds to a fourth connecting inner wall 233a, and the fifth connecting plate 225a corresponds to a fifth connecting inner wall 234a. The base 220a is directly formed on the first support plate of the cart, that is to say, the first connecting plate 221a, the second connecting plate 222a, the third connecting plate 223a, the fourth connecting plate 224a, and the fifth connecting plate 225a are directly formed by the first support plate.

The third connecting inner wall 232a and the fourth connecting inner wall 233a are connected to or formed with corresponding supporting ends with basically the same structures, specifically, a first supporting end 235a and a second supporting end 236a. The first supporting end 235a and the second supporting end 236a both protrude outward. The two sides of the connecting base are connected to the first supporting end 235a and the second supporting end 236a, respectively. For example, a first groove 237a and a second groove 238a that are adapted to the first supporting end 235a and the second supporting end 236a are formed on the two sides of the connecting base. The first supporting end 235a and the second supporting end 236a are cylindrical protrusions, and the first groove 237a and the second groove 238a are cylindrical grooves. The first supporting end 235a abuts against the first groove 237a, and the second supporting end 236a abuts against the second groove 238a. The connecting assembly 210a flips about the axis of the first supporting end 235a or the axis of the second supporting end 236a, thereby achieving state switching. Of course, the first supporting end 235a and the second supporting end 236a may be provided on the connecting base, and the first groove 237a and the second groove 238a may be provided on the third connecting inner wall 232a and the fourth connecting inner wall 233a.

The third connecting inner wall 232a and the fourth connecting inner wall 233a are both connected to or formed with stop portions with basically the same structures, which are a first stop portion 241a and a second stop portion 242a that correspond to each other and a third stop portion 243a and a fourth stop portion 244a that correspond to each other. Further, clamping portions are disposed on the two sides of the connecting base, which are a first clamping portion 245a and a second clamping portion 246a. The first stop portion 241a and the first clamping portion 245a can be adapted to each other, or the third stop portion 243a and the first clamping portion 245a can be adapted to each other. Similarly, the second stop portion 242a and the second clamping portion 246a can be adapted to each other, or the fourth stop portion 244a and the second clamping portion 246a can be adapted to each other. When the first stop portion 241a abuts against the first clamping portion 245a and the second stop portion 242a abuts against the second clamping portion 246a, the connecting assembly 210a is in the connection state. Moreover, the first stop portion 241a and the second stop portion 242a are used for preventing the connecting assembly 210a from moving when no external driving force exists. When the third stop portion 243a abuts against the first clamping portion 245a and the fourth stop portion 244a abuts against the second clamping portion 246a, the connecting assembly 210a is in the hidden state. Moreover, the third stop portion 243a and the fourth stop portion 244a are used for preventing the connecting assembly 210a from moving when no external driving force exists.

When the connecting assembly 210a is in the hidden state, the connecting base has at least one upward surface, which is defined as an end surface 247a. Along the up and down direction, the distance between the end surface 247a and the fifth connecting plate 225a is the farthest. The end surface 247a is lower than the surface of the first support plate, that is, lower than the storage surface of the first support plate. In this manner, when the user places items on the first support plate, the connecting assembly 210a does not prevent the user from placing items on the first connecting plate 221a, and the items placed on the first connecting plate 221a do not damage the connecting assembly 210a during transportation or handling. When the user needs to use the connector, the user only needs to switch the connecting assembly 210a to the connection state.

The original state of the connecting assembly 210a is defined here as the hidden state. In this case, the connector is in the accommodation cavity 226a. When the user wants to switch the connecting assembly 210a to the connection state, the user needs to fold the connecting assembly 210a upward with the contact part between the first supporting end 235a and the first groove 237a as the axis until the end surface 247a of the connecting assembly 210a abuts against the abutment surface of the first connecting plate 221a, and the connecting assembly 210a stops rotating, thereby switching the connecting assembly 210a from the hidden state to the connection state. When the user needs to switch the connecting assembly 210a from the connection state to the hidden state, the user only needs to rotate the connecting assembly 210a downward with the preceding contact part as the axis until the connecting assembly 210a cannot rotate anymore. In this case, the switching is completed.

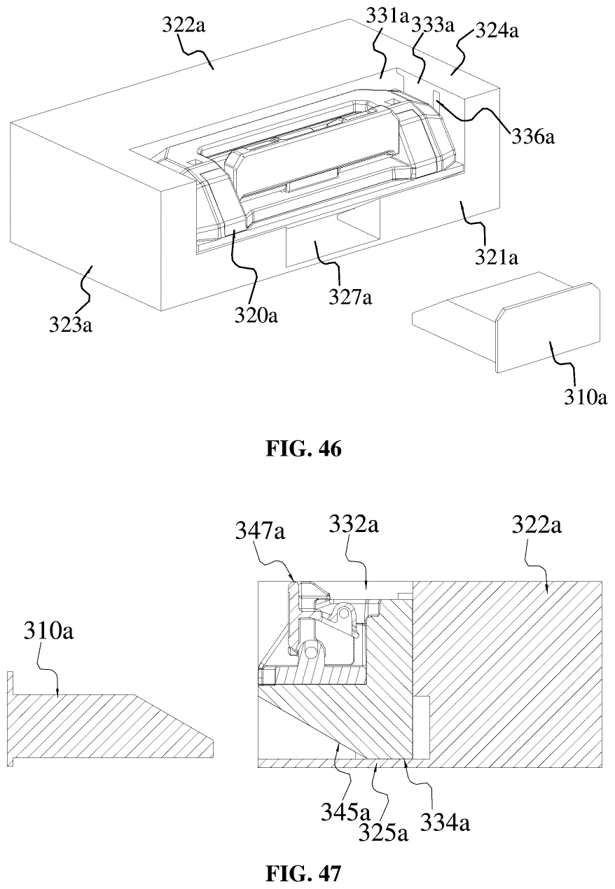

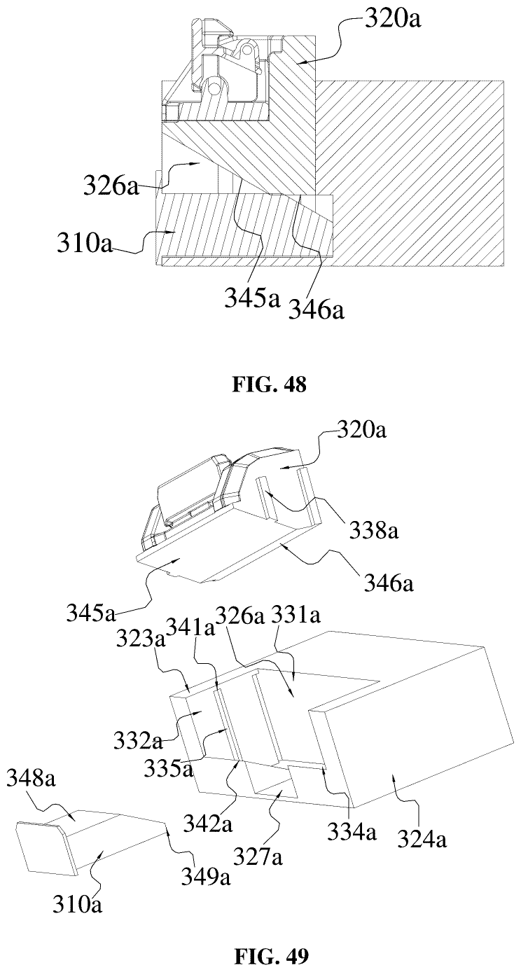

FIGS. 45 to 49 show a third example in which the connecting assembly is switched from the connection state to the hidden state relative to a base 320a. It is to be noted that the differences between example three and example one are the switching manner and the specific connection structure between the connecting assembly and the base 320a. Only the parts of example three which are different from those of example one are introduced here. For other structures, reference may be made to the above.

To clearly illustrate the technical solutions in this example, up, down, front, rear, left, and right are defined as shown in FIG. 45. It is to be noted that, unless otherwise specified, up and down, front and rear, and left and right are described below with respect to a stationary state of the connecting device shown in FIG. 45.

The connecting assembly further includes a driving member 310a. When the user needs to switch the connecting assembly from the connection state to the hidden state, the user may pull out the driving member 310a. In this case, the connecting assembly moves downward under the action of gravity until the connecting assembly is in an accommodation cavity 326a.

For example, the base 320a includes a first connecting plate 321a, a second connecting plate 322a, a third connecting plate 323a, a fourth connecting plate 324a, and a fifth connecting plate 325a. The first connecting plate 321a and the second connecting plate 322a are spaced apart. The third connecting plate 323a and the fourth connecting plate 324a are spaced apart. The fifth connecting plate 325a is connected to the first connecting plate 321a, the second connecting plate 322a, the third connecting plate 323a, and the fourth connecting plate 324a. The fifth connecting plate 325a is opposite to the upper surface of the base 320a. The third connecting plate 323a is connected to an end of the first connecting plate 321a and an end of the second connecting plate 322a, and the fourth connecting plate 324a is connected to the other end of the first connecting plate 321a and the other end of the second connecting plate 322a. Along the up and down direction, the length of the first connecting plate 321a is less than the length of the second connecting plate 322a, and the length of the third connecting plate 323a and the length of the fourth connecting plate 324a are each basically the same as the length of the second connecting plate 322a. That is to say, the first connecting plate 321a, the third connecting plate 323a, and the fourth connecting plate 324a roughly form a concave shape at the ends. The inner walls of the first connecting plate 321a, the second connecting plate 322a, the third connecting plate 323a, the fourth connecting plate 324a, and the fifth connecting plate 325a basically form a semi-enclosed accommodation cavity 326a with an upward opening, and the connecting assembly can be basically accommodated in the accommodation cavity 326a. A recessed accommodation groove 327a is formed on the first connecting plate 321a, and the accommodation groove 327a allows the driving member 310a to slide back and forth. The first connecting plate 321a corresponds to a first connecting inner wall, the second connecting plate 322a corresponds to a second connecting inner wall 331a, the third connecting plate 323a corresponds to a third connecting inner wall 332a, the fourth connecting plate 324a corresponds to a fourth connecting inner wall 333a, and the fifth connecting plate 325a corresponds to a fifth connecting inner wall 334a. The base 320a is directly formed on the first support plate of the cart, that is to say, the first connecting plate 321a, the second connecting plate 322a, the third connecting plate 323a, the fourth connecting plate 324a, and the fifth connecting plate 325a are directly formed by the first support plate.

Corresponding long grooves are connected to or formed on the third connecting inner wall 332a and the fourth connecting inner wall 333a, specifically a first groove 335a and a second groove 336a. Both the first groove 335a and the second groove 336a are recessed inward. The two sides of the connecting base mate with the first groove 335a and the second groove 336a, respectively. For example, protrusions are formed on two sides of the connecting base, specifically a first supporting end and a second supporting end 338a. The two ends of the first groove 335a are a first end 341a and a second end 342a. The first groove 335a basically extends along the up and down direction, and the first end 341a is located on the upper side relative to the second end 342a. Similarly, the two ends of the second groove 336a are a third end and a fourth end, the second groove 336a extends along the up and down direction, and the third end is located on the upper side relative to the fourth end. Due to the restriction and guidance of the first groove 335a and the second groove 336a, the bottom of the connecting base of the connecting assembly has a driving surface 345a and an abutment surface 346a that mate with the driving member 310a. The driving member 310a applies a force to the driving surface 345a to make the connecting assembly move upward until a front end surface 349a of the driving member 310a abuts against the second connecting inner wall 331a, and the connecting assembly stops moving. In this case, the abutment surface 346a of the connecting base abuts against an upper top surface 348a of the driving member 310a. Of course, when the driving member 310a is pulled out, the connecting assembly loses the external force and moves downward under the action of gravity until the abutment surface 346a abuts against the fifth connecting inner wall 334a.

When the connecting assembly is in the hidden state, the connector has at least one upward surface, which is defined as an end surface 347a. Along the up and down direction, the distance between the end surface 347a and the fifth connecting plate 325a is the farthest. The end surface 347a is lower than the surface of the first support plate, that is, lower than the storage surface of the first support plate. In this manner, when the user places items on the first support plate, the connecting assembly does not prevent the user from placing items on the first connecting plate 321a, and the items placed on the first connecting plate 321a do not damage the connecting assembly during transportation or handling. When the user needs to use the connector, the user only needs to switch the connecting assembly to the connection state.

The original state of the connecting assembly is defined as the hidden state, in which the connector is in the accommodation cavity 326a, the first end 341a of the first groove 335a abuts against the first supporting end, and the third end of the second groove 336a abuts against the second supporting end 338a. When the user wants to switch the connecting assembly to the connection state, the user needs to insert the driving member 310a into the accommodation groove 327a until the driving member 310a abuts against the driving surface 345a of the connecting base, and the user continues applying a force to drive the driving member 310a. The driving surface 345a is subjected to the force to move the connecting assembly upward until the first supporting end abuts against the second end 342a of the first groove 335a, and the second supporting end 338a abuts against the fourth end of the second groove 336a. Moreover, the abutment surface 346a of the connecting base abuts against the upper top surface 348a of the driving member 310a, and the front end surface 349a of the driving member 310a abuts against the second connecting inner wall 331a, thereby switching the connecting assembly from the hidden state to the connection state. When the user needs to switch the connecting assembly from the connection state to the hidden state, the user only needs to pull out the driving member 310a, the abutment surface 346a loses the external force, and the connecting assembly moves downward under the action of gravity until the first supporting end abuts against the first end 341a of the first groove 335a, and the second supporting end 338a abuts against the third end of the second groove 336a. Moreover, the abutment surface 346a of the connecting base abuts against the fifth connecting inner wall 334a. In this case, the connecting assembly is in the hidden state. In this case, the switching is completed.

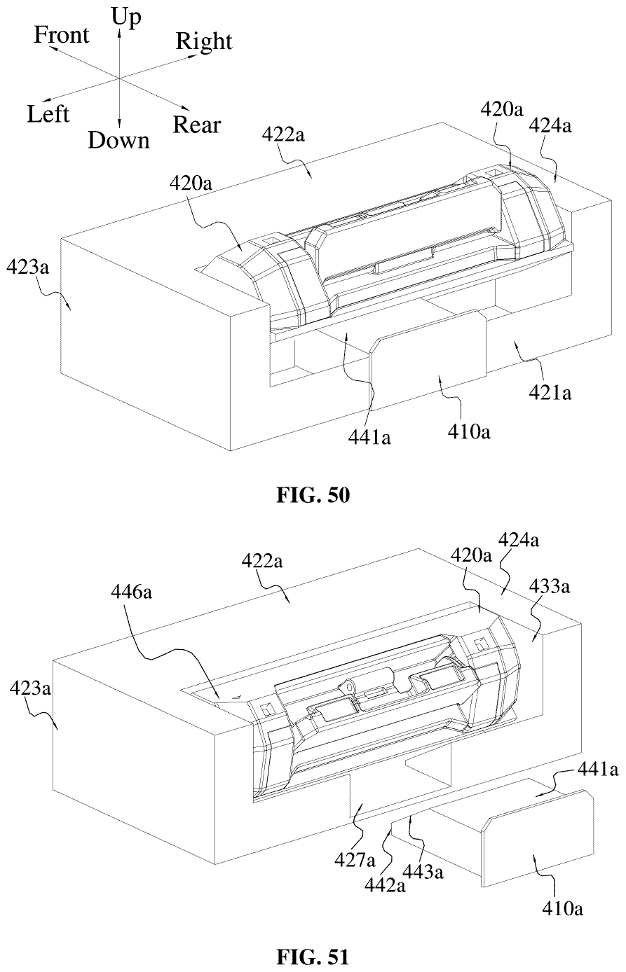

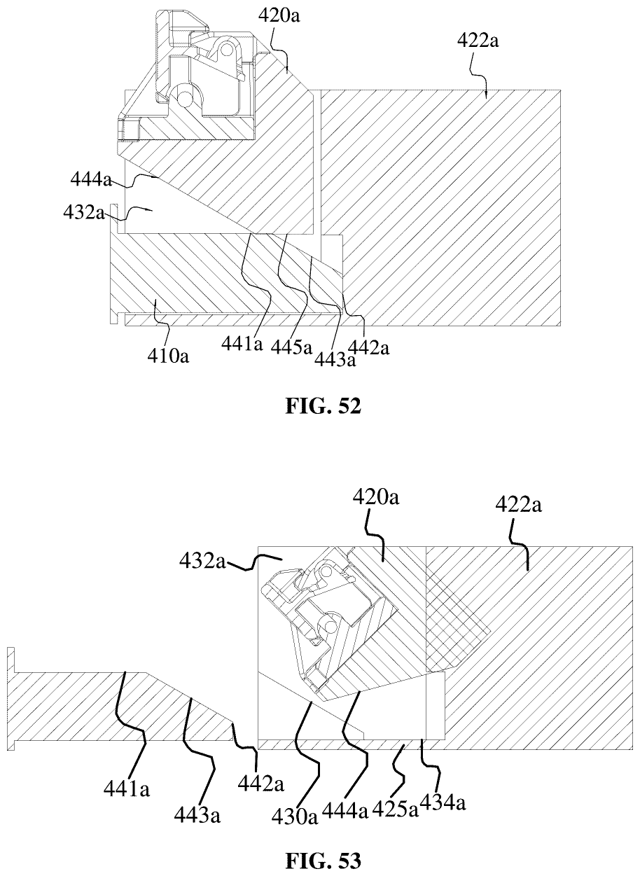

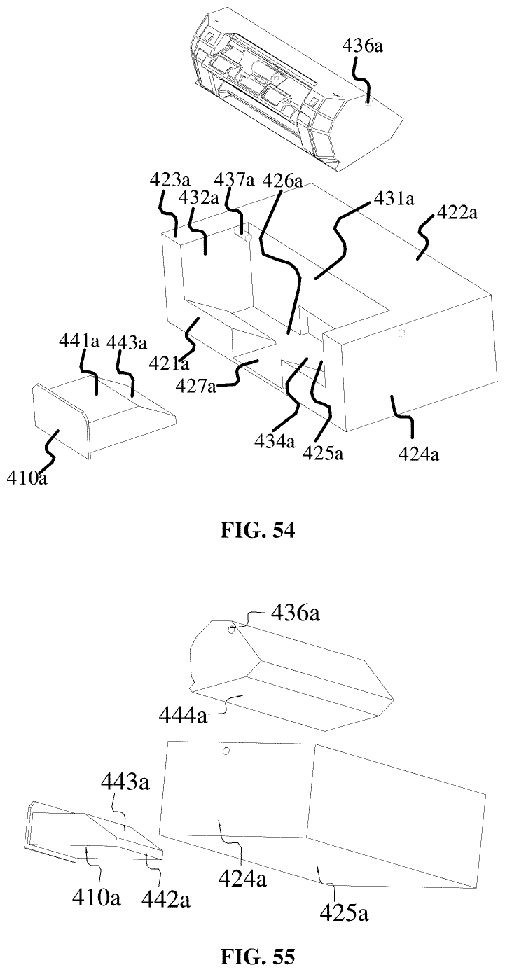

FIGS. 50 to 55 show a fourth example in which the connecting assembly is switched from the connection state to the hidden state relative to a base 420a. It is to be noted that the differences between example four and example one are the switching manner and the specific connection structure between the connecting assembly and the base 420a. Only the parts of example four which are different from those of example one are introduced here. For other structures, reference may be made to the above.

To clearly illustrate the technical solutions in this example, up, down, front, rear, left, and right are defined as shown in FIG. 50. It is to be noted that, unless otherwise specified, up and down, front and rear, and left and right are described below with respect to a stationary state of the connecting device shown in FIG. 50.

The connecting assembly further includes a driving member 410a. When the user needs to switch the connecting assembly from the connection state to the hidden state, the user may pull out the driving member 410a. In this case, the connecting assembly flips downward under the action of gravity until the connecting assembly is in an accommodation cavity 426a.

For example, the base 420a includes a first connecting plate 421a, a second connecting plate 422a, a third connecting plate 423a, a fourth connecting plate 424a, and a fifth connecting plate 425a. The first connecting plate 421a and the second connecting plate 422a are spaced apart. The third connecting plate 423a and the fourth connecting plate 424a are spaced apart. The fifth connecting plate 425a is connected to the first connecting plate 421a, the second connecting plate 422a, the third connecting plate 423a, and the fourth connecting plate 424a. The fifth connecting plate 425a is opposite to the upper surface of the base 420a. The third connecting plate 423a is connected to an end of the first connecting plate 421a and an end of the second connecting plate 422a, and the fourth connecting plate 424a is connected to the other end of the first connecting plate 421a and the other end of the second connecting plate 422a. Along the up and down direction, the length of the first connecting plate 421a is less than the length of the second connecting plate 422a, and the length of the third connecting plate 423a and the length of the fourth connecting plate 424a are each basically the same as the length of the second connecting plate 422a. That is to say, the first connecting plate 421a, the third connecting plate 423a, and the fourth connecting plate 424a roughly form a concave shape at the ends. The inner walls of the first connecting plate 421a, the second connecting plate 422a, the third connecting plate 423a, the fourth connecting plate 424a, and the fifth connecting plate 425a basically form a semi-enclosed accommodation cavity 426a with an upward opening, and the connecting assembly can be basically accommodated in the accommodation cavity 426a. A recessed accommodation groove 427a is formed on the first connecting plate 421a, and the accommodation groove 427a allows the driving member 410a to slide back and forth. The first connecting plate 421a corresponds to a first connecting inner wall 430a, the second connecting plate 422a corresponds to a second connecting inner wall 431a, the third connecting plate 423a corresponds to a third connecting inner wall 432a, the fourth connecting plate 424a corresponds to a fourth connecting inner wall 433a, and the fifth connecting plate 425a corresponds to a fifth connecting inner wall 434a. The base 420a is directly formed on the first support plate of the cart, that is to say, the first connecting plate 421a, the second connecting plate 422a, the third connecting plate 423a, the fourth connecting plate 424a, and the fifth connecting plate 425a are directly formed by the first support plate.

The third connecting inner wall 432a and the fourth connecting inner wall 433a are connected to or formed with corresponding supporting ends, specifically, a first supporting end 437a and a second supporting end 438a. The first supporting end 437a and the second supporting end 438a both protrude outward. The two sides of the connecting base are connected to the first supporting end 437a and the second supporting end 438a, respectively. For example, a first groove and a second groove 436a that are adapted to the first supporting end 437a and the second supporting end 438a are formed on the two sides of the connecting base. The first supporting end 437a and the second supporting end 438a are cylindrical protrusions, and the first groove and the second groove 436a are cylindrical grooves. The first supporting end 437a abuts against the first groove, and the second supporting end 438a abuts against the second groove 436a. The connecting assembly rotates about the axis of the first supporting end 437a or the axis of the second supporting end 438a, thereby achieving state switching. Of course, the first supporting end 437a and the second supporting end 438a may be provided on the connecting base, and the first groove and the second groove 436a may be provided on the third connecting inner wall 432a and the fourth connecting inner wall 433a. The driving member 410a includes an upper top surface 441a, a front end surface 442a, and an intermediate surface 443a connecting the upper top surface 441a to the front end surface 442a. The connecting base has a driving surface 444a mating with the intermediate surface 443a and an abutment surface 445a mating with the upper top surface 441a.

When the connecting assembly is in the hidden state, the connector has at least one upward surface, which is defined as an end surface 446a. Along the up and down direction, the distance between the end surface 446a and the fifth connecting plate 425a is the farthest. The end surface 446a is lower than the surface of the first support plate, that is, lower than the storage surface of the first support plate. In this manner, when the user places items on the first support plate, the connecting assembly does not prevent the user from placing items on the first connecting plate 421a, and the items placed on the first connecting plate 421a do not damage the connecting assembly during transportation or handling. When the user needs to use the connector, the user only needs to switch the connecting assembly to the connection state.

The original state of the connecting assembly is defined as the hidden state, in which the connector is in the accommodation cavity 426a, the first end of the first groove abuts against the first supporting end 437a, and the third end of the second groove 436a abuts against the second supporting end 438a. When the user wants to switch the connecting assembly to the connection state, the user needs to insert the driving member 410a into the accommodation groove 427a until the intermediate surface 443a abuts against the driving surface 444a of the connecting base, and the user continues applying a force to drive the driving member 410a. The driving surface 444a is subjected to the force to flip the connecting assembly upward about the axis of the first supporting end 437a or the axis of the second supporting end 438a until the abutment surface 445a of the connecting base abuts against the upper top surface 441a of the driving member 410a, and the front end surface 442a of the driving member 410a abuts against the second connecting inner wall 431a, thereby switching the connecting assembly from the hidden state to the connection state. When the user needs to switch the connecting assembly from the connection state to the hidden state, the user only needs to pull out the driving member 410a, the abutment surface 445a loses the external force, and the connecting assembly flips downward about the axis of the first supporting end 437a or the axis of the second supporting end 438a under the action of gravity until the abutment surface 445a of the connecting base abuts against the fifth connecting inner wall 434a. In this case, the connecting assembly is in the hidden state. In this case, the switching is completed.

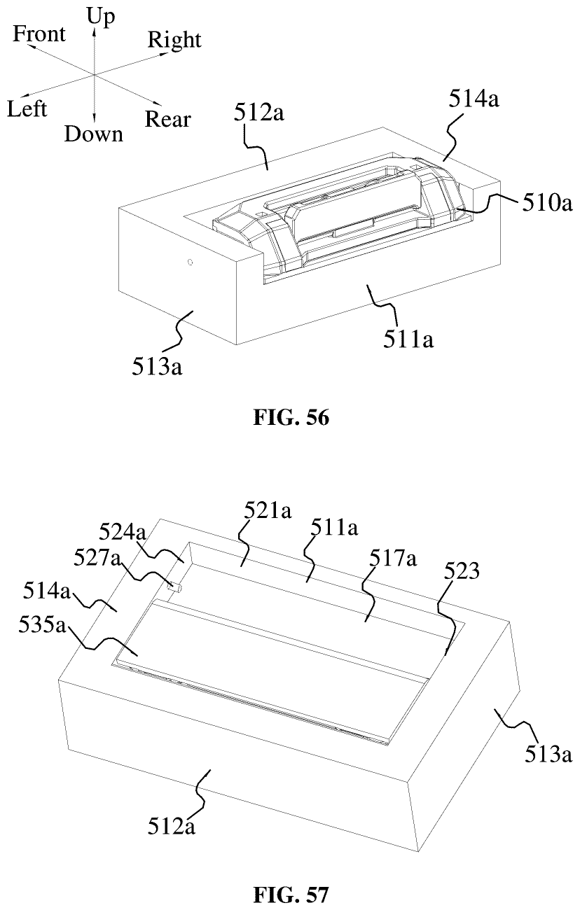

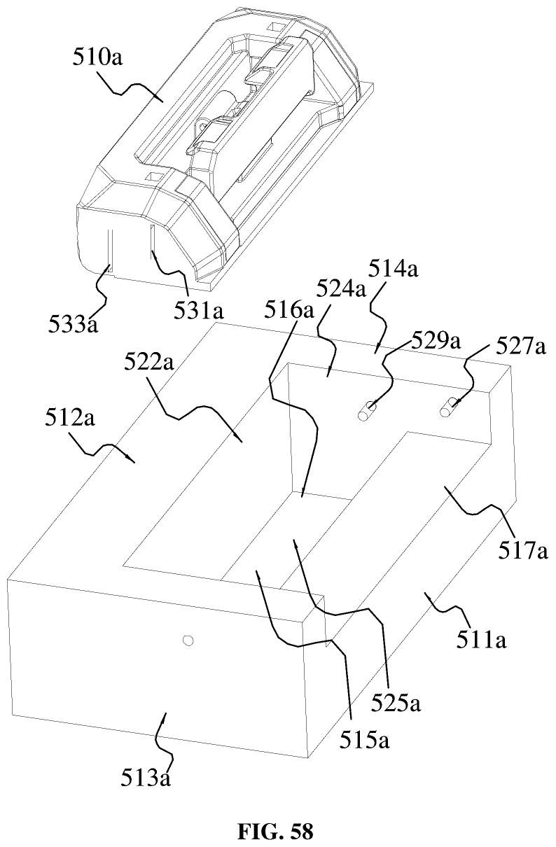

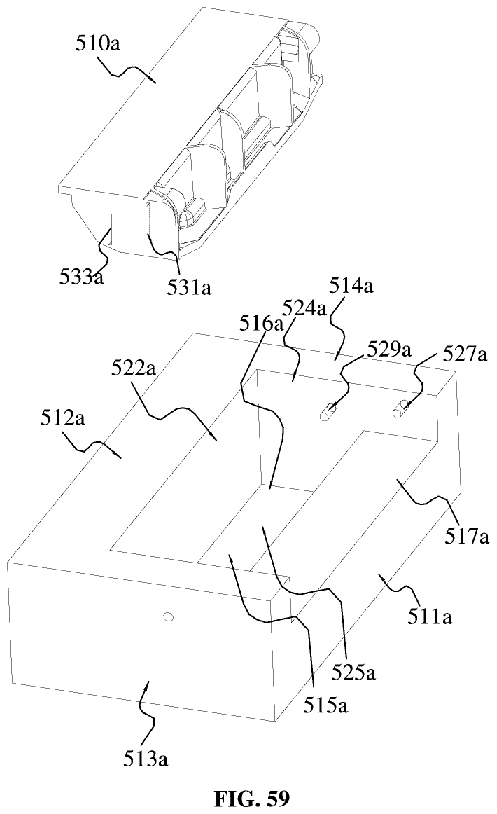

FIGS. 56 to 59 show a fifth example in which the connecting assembly is switched from the connection state to the hidden state relative to a base 510a. It is to be noted that the differences between example five and example one are the switching manner and the specific connection structure between the connecting assembly and the base 510a. Only the parts of example five which are different from those of example one are introduced here. For other structures, reference may be made to the above.

To clearly illustrate the technical solutions in this example, up, down, front, rear, left, and right are defined as shown in FIG. 56. It is to be noted that, unless otherwise specified, up and down, front and rear, and left and right are described below with respect to a stationary state of the connecting device shown in FIG. 56.

When the user needs to switch the connecting assembly from the connection state to the hidden state, the user may remove the connecting assembly from an accommodation cavity 516a.

For example, the base 510a includes a first connecting plate 511a, a second connecting plate 512a, a third connecting plate 513a, a fourth connecting plate 514a, and a fifth connecting plate 515a. The first connecting plate 511a and the second connecting plate 512a are spaced apart. The third connecting plate 513a and the fourth connecting plate 514a are spaced apart. The fifth connecting plate 515a is connected to the first connecting plate 511a, the second connecting plate 512a, the third connecting plate 513a, and the fourth connecting plate 514a. The fifth connecting plate 515a is opposite to the upper surface of the base 510a. The third connecting plate 513a is connected to an end of the first connecting plate 511a and an end of the second connecting plate 512a, and the fourth connecting plate 514a is connected to the other end of the first connecting plate 511a and the other end of the second connecting plate 512a. Along the up and down direction, the length of the first connecting plate 511a is less than the length of the second connecting plate 512a, and the length of the third connecting plate 513a and the length of the fourth connecting plate 514a are each basically the same as the length of the second connecting plate 512a. It may also be understood as that the first connecting plate 511a, the third connecting plate 513a, and the fourth connecting plate 514a basically form a concave shape at the ends. The inner walls of the first connecting plate 511a, the second connecting plate 512a, the third connecting plate 513a, the fourth connecting plate 514a, and the fifth connecting plate 515a basically form a semi-enclosed accommodation cavity 516a with an upward opening, and the connecting assembly can be basically accommodated in the accommodation cavity 516a. The upper end of the first connecting plate 511a has an abutment surface 517a. When the connecting assembly is in the connection state, the abutment surface 517a abuts against the connecting base. In this manner, when the toolbox is mounted to the connecting assembly, the abutment surface 517a can form a stable support for the connecting assembly. Of course, the first connecting plate 511a may also have other structures. For example, the upper surface of the first connecting plate 511a may be partially recessed downward to form the abutment surface 517a. The abutment surface 517a is configured to abut against the connecting base when the connecting assembly is in the connection state. Of course, a portion of the fifth connecting plate 515a may protrude to form the abutment surface 517a, and the abutment surface 517a is configured to abut against the connecting base when the connecting assembly is in the connection state.

The first connecting plate 511a corresponds to a first connecting inner wall 521a, the second connecting plate 512a corresponds to a second connecting inner wall 522a, the third connecting plate 513a corresponds to a third connecting inner wall 523a, the fourth connecting plate 514a corresponds to a fourth connecting inner wall 524a, and the fifth connecting plate 515a corresponds to a fifth connecting inner wall 525a. The base 510a is directly formed on the first support plate of the cart, that is to say, the first connecting plate 511a, the second connecting plate 512a, the third connecting plate 513a, the fourth connecting plate 514a, and the fifth connecting plate 515a are directly formed by the first support plate.

Corresponding supporting ends are connected to or formed on the third connecting inner wall 523a and the fourth connecting inner wall 524a, specifically a first supporting end, a second supporting end 527a, a third supporting end, and a fourth supporting end 529a. The first supporting end and the third supporting end are disposed on a side of the connecting base, the second supporting end 527a and the fourth supporting end 529a are disposed on a side of the connecting base, and all the preceding supporting ends protrude outward. The two sides of the connecting base are connected to the first supporting end, the second supporting end 527a, the third supporting end, and the fourth supporting end 529a. For example, two groups of long grooves are formed on two sides of the connecting base, specifically a first groove 531a, a second groove, a third groove 533a, and a fourth groove. The depth of each of the preceding four grooves increases from an end to the other end. The first groove 531a and the second groove basically correspond to each other and are arranged on two sides of the connecting base. Similarly, the third groove 533a and the fourth groove basically correspond to each other and are arranged on two sides of the connecting base. That is to say, the first groove 531a and the third groove 533a are disposed on the same side of the connecting base, and the second groove and the fourth groove are disposed on the same side of the connecting base. The extension directions of the first groove 531a and the third groove 533a from shallow to deep are basically opposite, and the bottoms of the first groove 531a, the second groove, the third groove 533a, and the fourth groove are the deepest parts of the grooves. The connecting base may be inserted into the base 510a through the first groove 531a and the second groove with the guidance of the first supporting end and the second supporting end 527a. In this case, the connector is at a connection position where the connector is connectable to the toolbox, and the connecting base abuts against the abutment surface 517a. The connecting base may also be inserted into the accommodation cavity 516a through the third groove 533a and the fourth groove with the guidance of the third supporting end and the fourth supporting end 529a. In this case, the connecting assembly is in the hidden state.

The original state of the connecting assembly is defined as the hidden state, in which the connector is in the accommodation cavity 516a. In this case, the bottom of the third groove 533a abuts against the third supporting end, and the bottom of the fourth groove abuts against the fourth supporting end 529a. When the user wants to switch the connecting assembly to the connection state, the user needs to lift the connecting assembly upward so that the bottom of the third groove 533a is separated from the third supporting end, and the bottom of the fourth groove is separated from the fourth supporting end 529a until the third supporting end slides out of the third groove 533a, and the fourth supporting end 529a slides out of the fourth groove. The user flips the connecting assembly over so that the connector is upward. The user inserts the connecting assembly into the base 510a through the first groove 531a and the second groove with the guidance of the first supporting end and the second supporting end 527a until the first supporting end abuts against the bottom wall of the first groove 531a, and the second supporting end 527a abuts against the bottom wall of the second groove. In this case, the connecting base abuts against the abutment surface 517a, and the connecting assembly switches from the hidden state to the connection state.

When the connecting assembly is in the hidden state, the connecting base has at least one upward surface, which is defined as an end surface 535a. Along the up and down direction, the distance between the end surface 535a and the fifth connecting plate 515a is the farthest. The end surface 535a is lower than the surface of the first support plate, that is, lower than the storage surface of the first support plate. In this manner, when the user places items on the first support plate, the connecting assembly does not prevent the user from placing items on the first connecting plate 511a, and the items placed on the first connecting plate 511a do not damage the connecting assembly during transportation or handling. When the user needs to use the connector, the user only needs to switch the connecting assembly to the connection state.

In the present application, when the connecting assembly is in the hidden state, at least two steps are required to connect the connecting assembly to the to-be-mounted part.

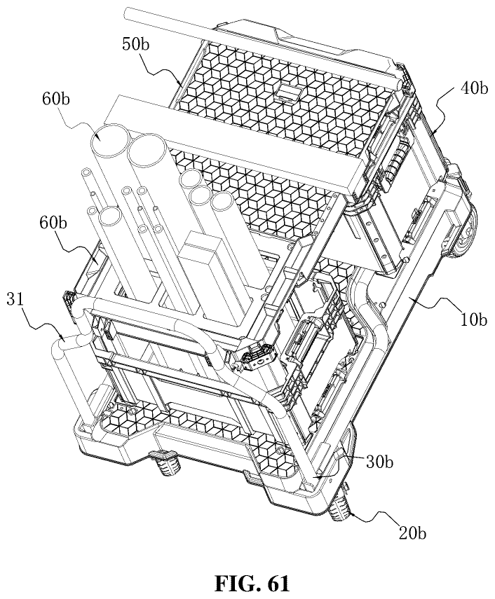

FIG. 61 shows a cart 100b applicable to the transportation and placement of a storage container 40b. From the viewpoint of working conditions, a user generally needs to carry items 60b to be used when going to a workplace. To make it convenient for the user to carry and transport the items 60b, the user generally stores the items 60b in the storage container 40b. The user may place, hang, or fix the storage container 40b or tools on or to the cart 100b so that the user may use the cart 100b to transport the storage container 40b to the workplace, place the tools in the workplace, or mount a workbench on the cart 100b, where the workbench serves as a temporary workbench for placing a machine or is set as a temporary office space.

The items 60b refer to one or a combination of an attachment, a tool, a charging device, a power supply device, a lighting device, an accessory box 55b/an accessory bag, a toolbox, an auxiliary tool, a garden tool, and the like.

To clearly describe the structure of the cart 100b and working principles thereof, up, down, front, rear, left, and right are defined, as shown in FIG. 61. It is to be noted that, unless otherwise specified, up and down, front and rear, and left and right are described below with respect to a stationary state shown in FIG. 61.

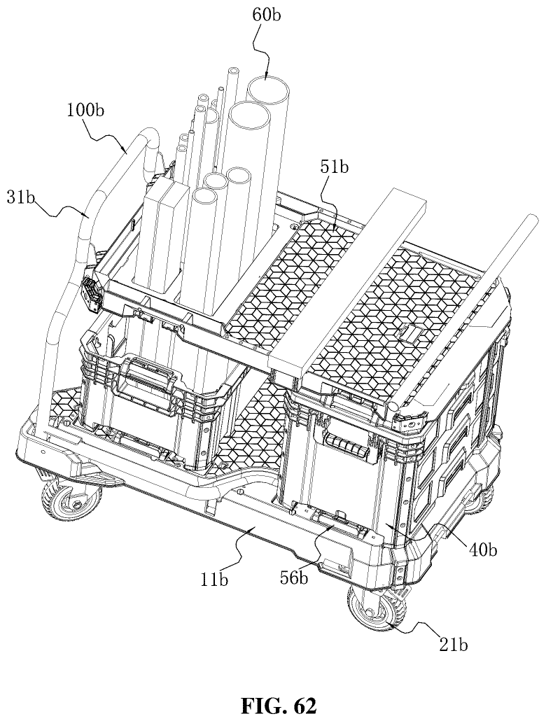

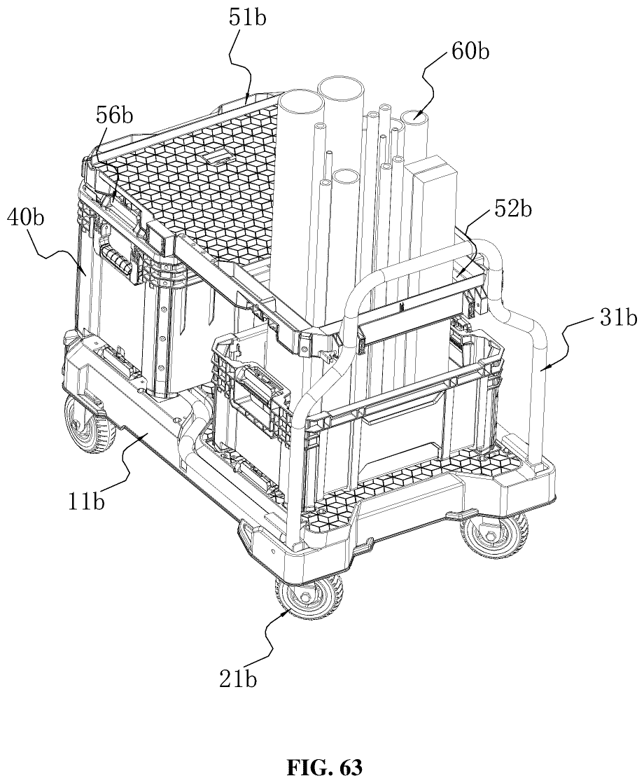

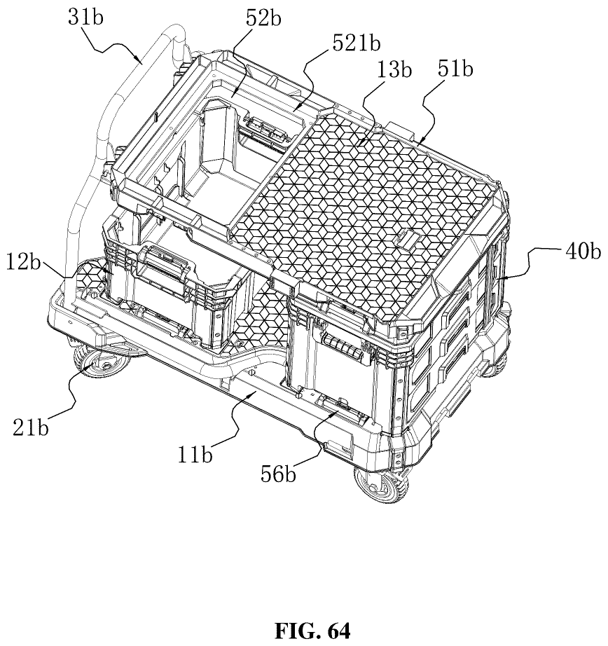

As shown in FIGS. 61 to 65, the cart 100b includes a base plate assembly 10b, a first support assembly 50b, a walking assembly 20b, and a pull rod assembly 30b.

The walking assembly 20b is connected to the base plate assembly 10b. In an up and down direction, the walking assembly 20b is disposed under the base plate assembly 10b. The walking assembly 20b includes one or more wheels 21b and enables the base plate assembly 10b to move relative to the ground. The user may push or pull the pull rod assembly 30b so that the wheels 21b rotate relative to the ground and drive the base plate assembly 10b to move. It is to be noted that the ground is not limited to the ground surface and may refer to another contact surface for placing the cart 100b.

The base plate assembly 10b is at least partially disposed on the walking assembly 20b. The base plate assembly 10b includes a base plate 11b, and the wheels 21b are substantially mounted at the lower end of the base plate 11b. The base plate 11b is used for stacking the storage container 40b, the attachment, the tool, the charging device, the power supply device, the lighting device, and the like. Of course, the attachment, the tool, the charging device, the power supply device, and the lighting device may be placed in the storage container 40b, and then the storage container 40b may be placed on the base plate 11b.

The pull rod assembly 30b is connected to the base plate assembly 10b. The pull rod assembly 31b includes a pull rod 31b. The pull rod 31b includes a first connecting rod and a second connecting rod opposite to each other and substantially extending along a direction of a straight line and a grip rod connecting an end of the first connecting rod to an end of the second connecting rod. The user holds the grip rod to drive the cart 100b to move. The other end of the first connecting rod and the other end of the second connecting rod are pivotally connected to the base plate 11b. The pull rod 31b is rotatably connected to the base plate 11b. During rotation, the pull rod 31b has at least a stored state and a used state. The base plate 11b is formed with an upper recess. When the pull rod 31b is in the stored state, the pull rod 31b is stored in the upper recess, and the pull rod 31b is lower than the upper surface of the base plate 11b. When the pull rod 31b is in the used state, the pull rod 31b and the base plate 11b are at a certain angle. The specific angle between the pull rod 31b and the base plate 11b is not limited, and the pull rod 31b may rotate relative to the base plate 11b steplessly or in a gear adjustment manner. In this example, the pull rod 31b rotates relative to the base plate 11b steplessly, that is, the user may rotate the pull rod 31b as required by the user. As another example, the pull rod 31b also has a separated state relative to the base plate 11b. That is, the pull rod 31b may be detached from the base plate 11b, which may also be understood as follows: the base plate assembly 10b and the walking assembly 20b cooperate to form a dolly.

The first support assembly 50b is disposed on the upper side of the base plate assembly 10b. The first support assembly 50b includes a first support plate 51b disposed at the upper end of the base plate 11b. The first support plate 51b has at least a first state, a second state, and a third state relative to the base plate 11b. When the first support plate 51b is in the first state, the first support plate 51b is connected to the base plate 11b through at least one storage container. When the first support plate 51b is in the second state, the first support plate 51b is directly mounted on the base plate 11b. When the first support plate 51b is in the third state, the first support plate 51b is separated from the base plate 11b. In this manner, the user can select different states according to actual working conditions, greatly increasing the diversity of functions of the cart 100b. Of course, the user may dispose a second support assembly, a third support assembly, or the like on the first support plate 51b through the storage container 40b. Additionally, when the first support plate 51b is in any one state, the state can be used in combination with three states of the pull rod 31b relative to the base plate 11b separately so that the user can select use states according to the current working condition, facilitating operations.

As one example of the connection between the first support assembly 50b and the base plate assembly 10b, the first support assembly 50b is connected above the base plate assembly 10b through the pull rod 31b and the storage container 40b. The first support assembly 50b and the pull rod assembly 30b may be connected to each other through one or a combination of an insert pin, a snap, a screw, a plug-in component, and the like. The specific structure of a first connecting assembly is not limited herein as long as the first connecting rod and the second connecting rod can be fixedly connected to the first support plate 51b. As one example, the first support plate 51b and the pull rod assembly 30b are connected to each other through the insert pin. That is, the cart 100b further includes the first connecting assembly. The first connecting assembly is used for connecting the pull rod assembly 30b to the first support assembly 50b and fixedly connecting the pull rod 31b to the first support plate 51b. The preceding configuration may be understood as follows: the user may mount the first support plate 51b above the base plate 11b through the first connecting assembly and the storage container 40b. To ensure the stability of the connection between the pull rod 31b and the first support plate 51b, the first connecting assembly may be mounted on each of the first connecting rod and the second connecting rod. The first connecting assembly mounted on the first connecting rod is used as an example. The first connecting assembly includes a first connector, a second connector, and a fastener. The first connector is connected to or formed on the first connecting rod, the second connector is connected to or formed on the first support plate 51b, and the fastener is used for keeping the first connector and the second connector relatively fixed, thereby keeping the first connecting rod and a first support member relatively fixed. Specifically, corresponding through holes are formed on the first connector and the second connector. The user inserts fasteners through the through holes of the first connector and the second connector, thereby keeping the first connecting rod and the first support plate 51b relatively fixed.

The storage container 40b and the first support plate 51b are detachably connected to each other in various manners. The storage container 40b and the first support plate 51b may be connected to each other through one or a combination of a screw thread, a snap, and an insert pin. As a feasible example, the storage container 40b and the first support plate 51b are connected to each other through two mounting assemblies 56b. The two mounting assemblies 56b are symmetrically disposed on two sides of the storage container 40b, respectively. One of the mounting assemblies 56b is used as an example. The mounting assembly 56b includes a resilient snap member 561b and a positioning member 562b. The snap member 561b is connected to the upper top wall of the storage container 40b, and the positioning member 562b is connected to the lower end of the first support plate 51b. When the user needs to connect the first support plate 51b to the storage container 40b, the first support plate 51b is placed downward so that the snap member 561b and the positioning member 562b are locked, thereby connecting the first support plate 51b to the storage container 40b. When the user needs to detach the first support plate 51b from the storage container 40b, the snap member 561b is simply pulled outward so that the snap member 561b and the positioning member 562b are separated from each other and then the first support plate 51b can be removed from the storage container 40b. Similarly, the storage container 40b and the base plate 11b may also adopt the same connecting structure as that between the storage container 40b and the first support plate 51b.

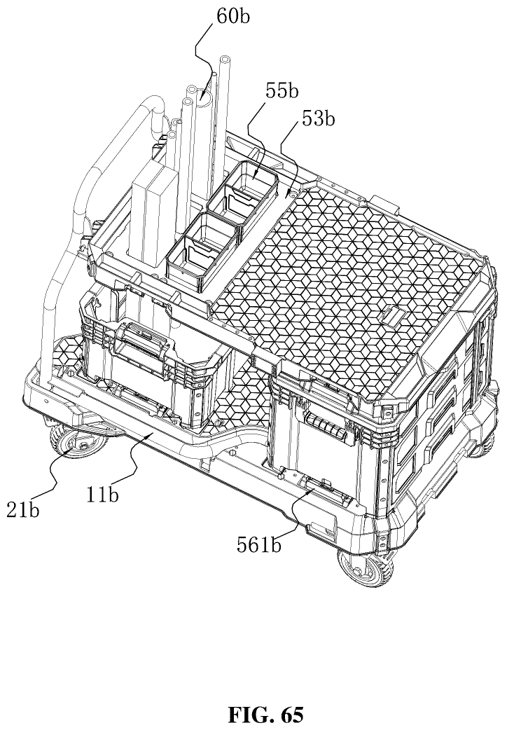

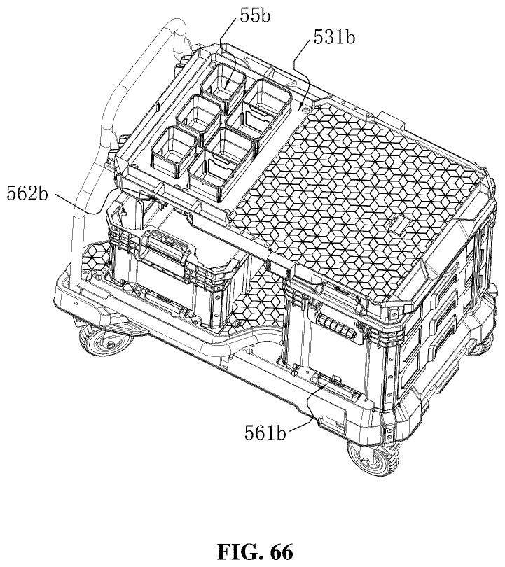

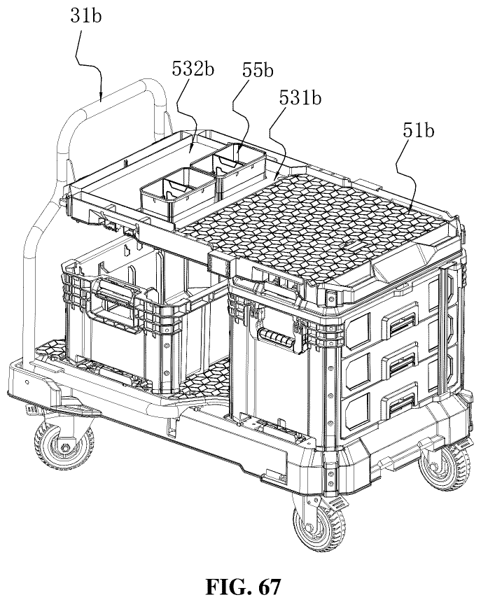

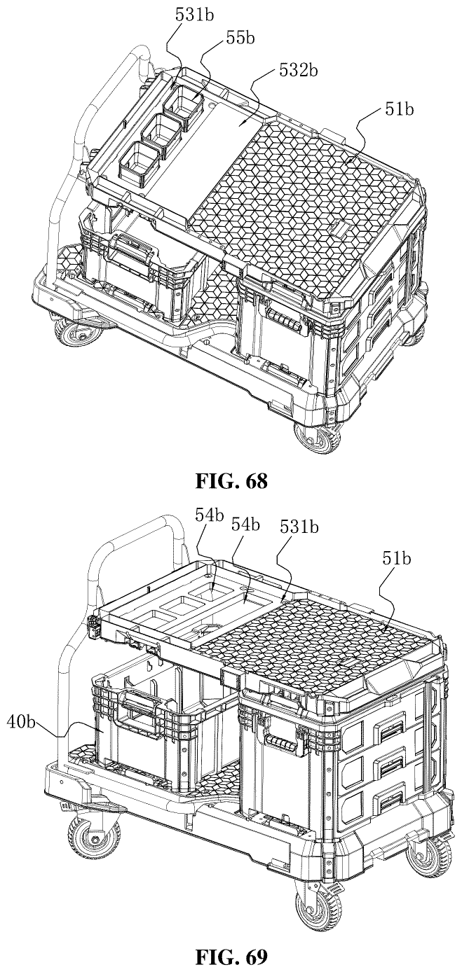

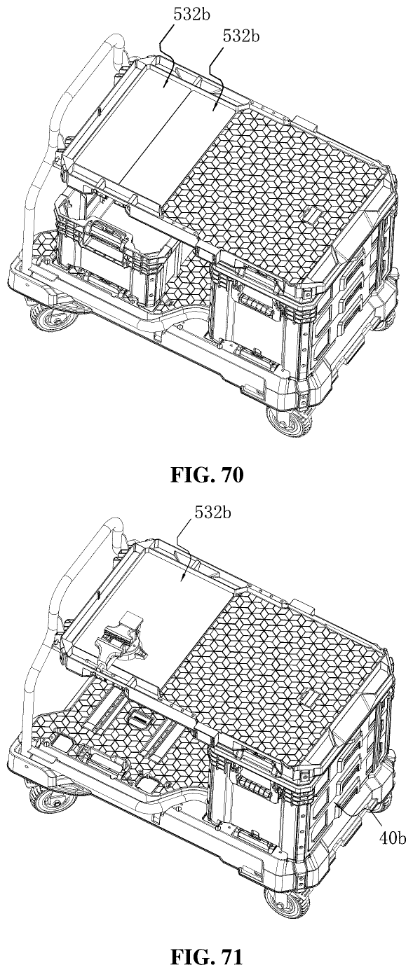

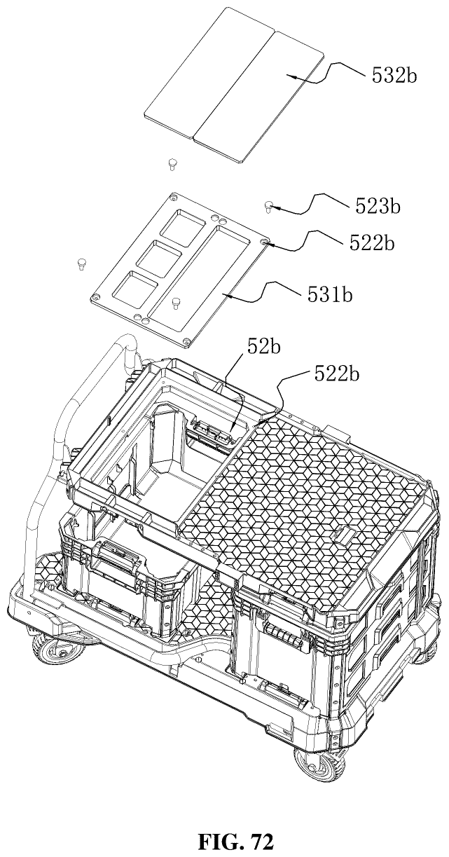

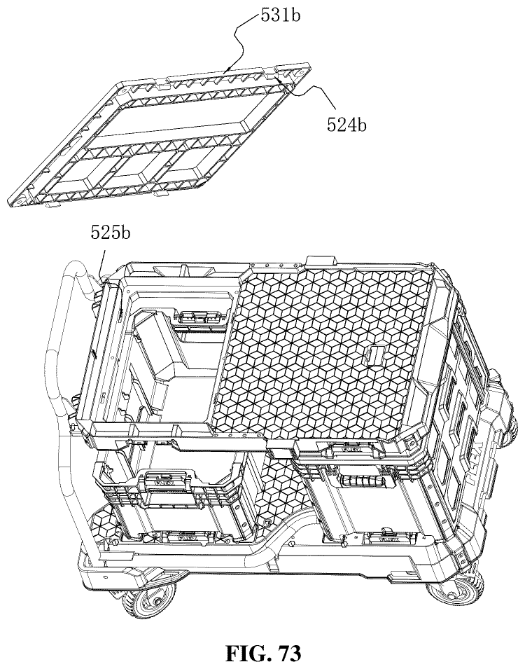

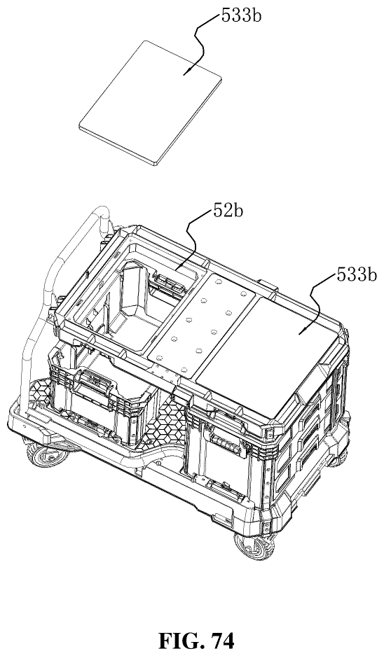

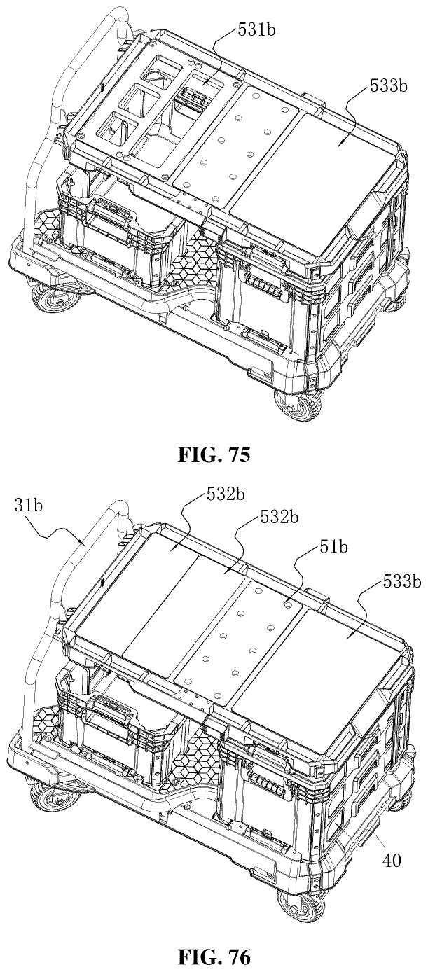

As shown in FIGS. 65 to 76, an opening 52b is connected to or formed on the first support plate 51b. When the first support plate 51b is in the first state, the first support plate 51b is connected above the base plate 11b through the pull rod 31b and the storage container 40b. That is, spaces where the items 60b can be placed are formed above both the base plate 11b and the first support plate 51b. The spaces where the items 60b can be placed are defined as a first storage space 12b and a second storage space 13b, respectively. The opening 52b is connected to or formed on the first support plate 51b and can penetrate through the first storage space 12b and the second storage space 13b. When the user uses the cart 100b to transport, carry, or place the items 60b, there are often some elongated tools, some pieces to be cut, and some pieces to be machined, such as a pole sander, a vacuum cleaner, a string trimmer, a blower, a level, a pipe, and lumber. These elongated items 60b usually cause great inconvenience to the user when being transported, carried, or placed. The user generally prepares other transportation tools for such elongated items 60b, which increases the burden of transporting and carrying the elongated items 60b on the user and affects the work efficiency of the user. The opening 52b is provided on the first support plate 51b to allow the first storage space 12b to communicate with the second storage space 13b. Thus, the user can directly insert the elongated items 60b into the opening 52b so that the bottoms of the elongated items 60b abut against the base plate 11b and the upper ends of the elongated items 60b are restricted from movement by the opening 52b. In this manner, the user can directly use the cart 100b to transport the elongated items 60b without additional transportation tools, which facilitates the operation of the user and increases the diversity of the functions of the cart 100b. To prevent the bottoms of the elongated items 60b from moving freely, the user may place a toolbox with an open top at the lower end corresponding to the opening 52b. Thus, the lower ends of the elongated items 60b can be restricted from movement within the space formed by the toolbox, thereby preventing the elongated items 60b from disengaging from the cart 100b.

As another example, the opening 52b may cooperate with a storage bag having an opening. That is, the user places the bottom of the storage bag on the base plate 11b and then connects the opening of the storage bag to the opening 52b. The storage bag is generally made of a flexible material. The opening of the storage bag is connected to the opening 52b so that the opening of the storage bag always remains open. Thus, it is convenient for the user to directly place the items 60b into the storage bag through the opening. The case is avoided where every time the storage bag is needed, the user has to stop working, open the storage bag, and then place the items 60b into the storage bag, which affects the work efficiency of the user. The storage bag may be made of any material with certain flexibility. For example, the storage bag may be made of plastics or non-woven fabrics.

In summary, the opening 52b is provided on the cart 100b so that the diversity of the functions of the cart 100b can be increased on the basis of the original functions thereof, which greatly facilitates the use of the user. In addition, the user does not need to prepare more types of transportation tools to transport the required tools to the workplace, thereby reducing the user's transportation cost.

The opening 52b may be provided at any position on the first support plate 51b. Multiple openings 52b may be provided on the first support plate 51b. The first support plate 51b is formed with one hole 54b, and the maximum length of the opening 52b along a front and rear direction is greater than or equal to 85 mm. The first support plate 51b is formed with one hole 54b, and the maximum length of the opening 52b along a left and right direction is greater than or equal to 85 mm. The opening 52b may have any shape and may be substantially circular, square, polygonal, or even irregular. The shape of the opening 52b is not limited herein.

As a feasible example, the opening 52b is substantially quadrilateral, and the cross-sectional area of the quadrilateral is substantially greater than or equal to 7000 square millimeters. This configuration provides a sufficient space for the user to place the elongated items 60b.

The cart 100b further includes at least one cover plate 53b, which is configured to be capable of being at least partially accommodated in the first support plate 51b. The cart 100b includes different types of cover plates 53b that may be accommodated in the opening 52b, and the opening 52b may accommodate different types of cover plates 53b. In addition, the opening 52b may simultaneously accommodate the different types of cover plates 53b. The different types of cover plates 53b may implement different functions. That is, the user may select a corresponding type of cover plate 53b according to the current working condition.

For ease of description, the cover plates are defined herein as a first type of cover plate 531b, a second type of cover plate 532b, and a third type of cover plate 533b. In the present application, unless otherwise specified, the cover plate 53b may encompass all types of cover plates 53b described herein.

The cover plate 53b has at least a first use state and a second use state relative to the first support plate 51b. When the cover plate 53b is in the first use state, the cover plate 53b is configured to be accommodated in the opening 52b of the first support plate 51b. When the cover plate 53b is in the second use state, the cover plate 53b is separated from the first support plate 51b. The user may switch the cover plate 53b between the first use state and the second use state as required. When the user needs to use the function of the cover plate 53b, the cover plate 53b may be mounted on the first support plate 51b. When the user only needs to use the function of the opening 52b, the user only needs to remove the cover plate 53b from the first support plate 51b so that the function of the opening 52b can be used. The cover plate 53b may be placed anywhere on the cart 100b. For example, the cover plate 53b may be placed above the base plate 11b, placed in the toolbox, or hung on the cart 100b as long as there is a sufficient space for placing the cover plate 53b. This configuration enables the user to switch the use state at any time.

As an example in which the cover plate 53b is accommodated in the opening 52b, a step surface 521b is circumferentially formed on the inner wall of the opening 52b. The step surface 521b is used as a support for the cover plate 53b. That is, after the cover plate 53b is embedded into the opening 52b, the cover plate 53b moves downward under the influence of gravity until the cover plate 53b is at least partially in contact with and supported by the step surface 521b and further the step surface 521b prevents the cover plate 53b from moving. With this configuration, the cover plate 53b can be mounted on the first support plate 51b. That is, the cover plate 53b is in the first use state. Similarly, the cover plate 53b is removed so that the cover plate 53b can be switched from the first use state to the second use state. The preceding configuration enables the cover plate 53b to switch between the use states without complicated operations. Thus, the operation of the user is facilitated, and the structure is simple and easy to machine and implement.

Of course, to ensure the stability of the connection between the cover plate 53b and the first support plate 51b, the cover plate 53b and the first support plate 51b may be fixedly connected to each other through one or a combination of a bolt, a snap, an insert pin, and the like. The connection manner and the connecting structure between the cover plate 53b and the first support plate 51b may not be specifically limited as long as the cover plate 53b and the first support plate 51b can be detachably connected to each other.

As a feasible example, the cover plate 53b and the first support plate 51b are connected to each other through bolts. That is, the cart 100b further includes locking members 523b, positioning holes 522b are provided on both the cover plate 53b and the step surface 521b, and the positioning holes 522b on the cover plate 53b correspond to the positioning holes 522b on the step surface 521b. When the positioning holes 522b on the cover plate 53b are aligned with those on the step surface 521b, the user may insert the locking members 523b through the positioning holes 522b on the cover plate 53b and the positioning holes 522b on the step surface 521b and then fasten the screws with nuts, thereby fixedly connecting the cover plate 53b to the first support plate 51b. To remove the cover plate 53b, the user only needs to loosen the nuts so that the cover plate 53b and the screws can be removed from the first support plate 51b.

As another connection manner between the cover plate 53b and the first support plate 51b, the cover plate 53b and the first support plate 51b are connected to each other through snaps. The cover plate 53b is connected to or formed with resilient snap portions 524b, and the first support plate 51b is connected to or formed with fitting portions 525b mated with the snap portions 524b. When the user intends to fix the cover plate 53b onto the first support plate 51b, the user brings the snap portions 524b into contact with the fitting portions 525b and then presses the cover plate 53b downward hard, causing the snap portions 524b to elastically deformed due to stress and be snapped into the fitting portions 525b, thereby fixing the cover plate 53b to the first support plate 51b. When the user intends to remove the cover plate 53b from the first support plate 51b, the snap portions 524b are driven to be released from the fitting portions 525b, and then the cover plate 53b is removed from the first support plate 51b.

Multiple openings 52b may be formed on the first support plate 51b, and any one of the openings 52b may accommodate at least one cover plate 53b. Different cover plates 53b can implement different functions, and more functions of the cart 100b are further implemented through combinations of different cover plates 53b.

The first type of cover plate 531b is formed with multiple holes 54b, and the holes 54b can allow the first storage space 12b to communicate with the second storage space 13b. The cross-sectional area of any one of the holes 54b is smaller than the cross-sectional area of the hole 54b mentioned above. For the elongated items 60b, if the user does not insert a sufficient number of elongated items 60b into the opening 52b, the elongated items 60b may shake during transportation. If the cart moves on a bumpy road, differences in the heights of the elongated items 60b may result in scratches between the elongated items 60b. The cover plate 53b is provided with the multiple holes 54b and the user inserts the elongated items 60b into the holes 54b so that the holes 54b can better restrict the movement ranges of the elongated items 60b. Thus, when only a few elongated items 60b are stored, these elongated items 60b are prevented from shaking strongly, and the elongated items 60b are stored in a replaceable manner, thereby facilitating the management of the user.

The hole 54b may be mated with the accessory box 55b, that is, the user may snap the accessory box 55b into the hole 54b. In most workplaces, it is necessary to use some small accessories such as nails and nuts. For such small accessories, the user generally places the small accessories into the accessory box 55b with an open top. In the workplace, the user may use the cart 100b as a display cart 100b for convenient access to the items 60b. The first type of cover plate 531b is mounted on the first support plate 51b such that the user may snap the accessory box 55b into the hole 54b and place the small accessories and the like in the accessory box 55b. Thus, it is convenient for the user to be capable of directly taking the items 60b from the accessory box 55b during work, thereby facilitating the use of the user. In addition, it is convenient for the user to manage small items 60b. Furthermore, the user may selectively mount or remove the first type of cover plate 531b according to an actual working condition. Alternatively, if this type of cover plate 53b is unnecessary, the user may replace this type of cover plate 53b with another type of cover plate 53b of his or her own accord, thereby increasing the diversity of the functions of the cart 100b.

The holes 54b on the first type of cover plate 531b may be distributed in various manners, and different distribution manners may be regarded as different styles of the first type of cover plate 531b. As a distribution manner, the holes 54b on the first type of cover plate 531b are distributed in two rows along the front and rear direction, and one or more holes 54b may be provided in each row. The user may place the pole-like items 60b into the preceding holes 54b or snap small accessory boxes 55b into the preceding holes 54b.

As one placement manner, the user may store the pole-like items 60b in holes 54b in a first row and snap the accessory boxes 55b into holes 54b in a second row. Alternatively, the user may snap the accessory boxes 55b into holes 54b in a first row and store the pole-like items 60b in holes 54b in a second row.

As a configuration manner of the first type of cover plate 531b, six holes 54b with substantially identical cross sections are provided on the first type of cover plate 531b, and three holes 54b are uniformly distributed in each row. As another configuration manner of the first type of cover plate 531b, four holes 54b are provided on the first type of cover plate 531b. One hole 54b is provided in the first row, and three holes 54b with substantially identical cross sections are provided in the second row. As another configuration manner of the first type of cover plate 531b, five holes 54b are provided on the first type of cover plate 531b. Two holes 54b are provided in the first row and have substantially identical cross sections, and three holes 54b are provided in the second row and have substantially identical cross sections. Only solutions that may be implemented are described above. Of course, the first type of cover plate 531b may be provided with fewer or more holes 54b.

The second type of cover plate 532b is a planar cover plate 53b. Two cover plates 532b of the second type may substantially close the opening 52b, and further, the second type of cover plates 532b are symmetrically disposed substantially. The second type of cover plate 532b has a top surface. When the second type of cover plate 532b is mounted on the holes 54b, the top surface of the second type of cover plate 532b is substantially flush with the bottom surface formed on or connected to the first support plate 51b. That is, the two cover plates 532b of the second type are mounted side by side on the opening 52b and can substantially close the opening 52b, thereby converting the cart 100b into an ordinary double-layer cart 100b. The second type of cover plate 532b is provided so that multiple functions of the cart 100b can be switched.

As an operation manner, one cover plate 532b of the second type is mounted on the opening 52b, that is, the size of the opening 52b is reduced to one half of the original size of the opening 52b. As described above, the user may place some elongated items 60b onto the cart 100b. That is, the opening 52b forms a large insert slot of the cart 100b, and the movement ranges of the upper ends of the elongated items 60b are restricted through the opening 52b. The one cover plate 532b of the second type is mounted on the opening 52b so that the size of the opening 52b can be reduced. Thus, when only a small number of elongated items 60b are placed on the cart 100b, the one cover plate 532b of the second type may restrict the size of the opening 52b, and the movement ranges of the upper ends of the elongated items 60b can be restricted. This configuration may also be understood as follows: the number of elongated items 60b placed on the cart 100b is adjusted through the second type of cover plate 532b. As another operation manner, the two cover plates 532b of the second type are disposed side by side on the first support plate 51b, that is, the opening 52b is closed by the second type of cover plates 532b. Thus, the user may convert the cart 100b into the ordinary double-layer cart 100b. When the two cover plates 532b of the second type close the opening 52b, the top surfaces of the two cover plates 532b of the second type are substantially flush with the bottom surface of the first support plate 51b. Thus, the user may also place the items 60b on the top surfaces of the two cover plates 532b of the second type.

Multiple cover plates 53b may be disposed side by side in the opening 52b. The user may place the first type of cover plate 531b and the second type of cover plate 532b side by side in the opening 52b, that is, the second type of cover plate 532b is disposed on the upper side of the first type of cover plate 531b. As an operation manner, the user directly places the first type of cover plate 531b onto the step surface 521b and then places the second type of cover plate 532b onto the first type of cover plate 531b. Since the second type of cover plate 532b closes part of the opening 52b, only the first type of cover plate 531b in one row remains available. This configuration may be understood as follows: the second type of cover plate 532b may close any row of holes 54b, that is, the user can choose, through the second type of cover plate 532b, to use which row of holes 54b. For the user, it is often not necessary to use too many holes 54b during transportation or placement. The user may choose to use a corresponding hole 54b according to the current working condition or a current requirement when using the cart 100b, and the items 60b can still be placed on the second type of cover plate 532b. The first type of cover plate 531b is used in conjunction with the second type of cover plate 532b so that the storage space of the cart 100b can be better used, thereby further increasing the diversity of the functions of the cart 100b and increasing the diversity of the choices of the user.

Regarding a manner in which the first type of cover plate 531b and the second type of cover plate 532b are assembled, the first type of cover plate 531b may be directly inserted into the opening 52b until the first type of cover plate 531b is in contact with the step surface 521b and then stops, and then, the second type of cover plate 532b may be inserted into the opening 52b until the second type of cover plate 532b is in contact with the first type of cover plate 531b and stops. In this case, the top surface of the second type of cover plate 532b is substantially flush with the bottom surface of the first support plate 51b. When the user intends to change the position of the second type of cover plate 532b, the user only needs to remove the second type of cover plate 532b, move the second type of cover plate 532b to the upper side of the other row of holes 54b, and insert the second type of cover plate 532b downward until the second type of cover plate 532b is in contact with the first type of cover plate 531b, thereby changing the position of the second type of cover plate 532b.

The third type of cover plate 533b is a planar cover plate 53b, and one cover plate 533b of the third type can substantially close the opening 52b. The user may use the third type of cover plate 533b as the workbench for performing operations such as machining a workpiece thereon.

The cover plate 53b may be made of various materials, for example, wood, plastics, or metal.

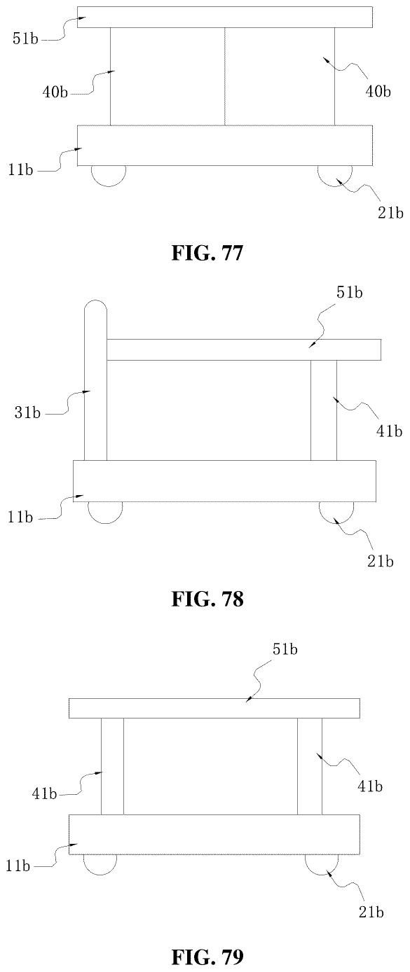

As shown in FIG. 77, as another example of the cart 100b, most of the structures are the same as those in the first example, and only the connection manner between the first support plate 51b and the base plate 11b is different. That is, the first support plate 51b is connected to the upper end of the base plate 11b through two storage containers 40b. The structures and principles of the opening 52b and the cover plate 53b are the same as those in the preceding example. Of course, as another example of the cart 100b, the first support plate 51b may be connected to the base plate 11b through more than two storage containers 40b.

As shown in FIG. 78, as another example of the cart 100b, most of the structures are the same as those in the first example, and only the connection manner between the first support plate 51b and the base plate 11b is different. As another example of the cart 100b, the cart 100b further includes a support leg assembly, and the first support plate 51b is connected to the base plate 11b through the support leg assembly. Specifically, the support leg assembly includes two support legs 41b, and the first support plate 51b is connected above the base plate 11b through the support legs 41b and the pull rods 31b. The structures and principles of the opening 52b and the cover plate 53b are the same as those in the preceding example.

As shown in FIG. 79, as another example of the cart 100b, most of the structures are the same as those in the first example, and only the connection manner between the first support plate 51b and the base plate 11b is different. Specifically, the cart 100b further includes the support leg assembly, and the first support plate 51b is connected to the base plate 11b through the support leg assembly. Specifically, the support leg assembly includes four support legs 41b, and the first support plate 51b is connected above the base plate 11b through the four support legs 41b. The structures and principles of the opening 52b and the cover plate 53b are the same as those in the preceding example.

The basic principles, main features, and advantages of the present application are shown and described above. It is to be understood by those skilled in the art that the preceding examples do not limit the present application in any form, and any technical solutions obtained through equivalent substitutions or equivalent transformations are within the scope of the present application.

What is claimed is:

1. A cart applicable to a storage box, comprising:
a wheel assembly comprising rotatable wheels;
a base plate assembly comprising a base plate connected to the wheel assembly; and
a first support plate having at least a first state relative to the base plate, wherein, when the first support plate is in the first state, the first support plate is connected to the base plate through at least one storage box.

2. The cart according to claim 1, wherein the first support plate has a second state and a third state relative to the base plate; when the first support plate is in the second state, the first support plate is mounted to the base plate, and the first support plate is at least partially in contact with the base plate; and, when the first support plate is in the third state, the first support plate is separated from the base plate.

3. The cart according to claim 2, further comprising a pull rod assembly connected to the base plate assembly, wherein the pull rod assembly comprises a pull rod connected to the base plate, the pull rod is movable relative to the base plate, the pull rod has at least two states relative to the base plate, the at least two states include a stored state and a used state, when the pull rod is in the stored state, the pull rod is at least partially within the base plate and the pull rod is lower than an upper surface of the base plate, and, when the pull rod is in the used state, the pull rod is connectable to the first support plate.

4. The cart according to claim 3, wherein the pull rod further has a separated state relative to the base plate, and when the pull rod is in the separated state, the pull rod is allowed to be separated from the base plate.

5. The cart according to claim 3, wherein three states of the first support plate relative to the base plate are each used in combination with two states of the pull rod relative to the base plate.

6. The cart according to claim 1, further comprising a pull rod assembly connected to the base plate assembly, wherein the pull rod assembly comprises a pull rod connected to the base plate, and the first support plate is connected to the base plate with an interval through the at least one storage box and the pull rod.

7. The cart according to claim 1, further comprising a pull rod assembly connected to the base plate assembly, wherein the pull rod assembly comprises a pull rod connected to the base plate, the cart further comprises a first connection assembly for connecting the pull rod to the first support plate, the first connection assembly comprises a first connector and a second connector, when the first connector is connected to the second connector, the first support plate is fixedly connected to the pull rod, and, when the first connector is separated from the second connector, the first support plate is separated from the pull rod and the first support plate and the pull rod are movable relative to the base plate.

8. The cart according to claim 7, wherein the first connection assembly further comprises a fastener capable of mating with the first connector and the second connector, the first connector is connected to the pull rod, the second connector is connected to the first support plate, the first connector is formed with first connection holes, the second connector is formed with second connection holes, and the fastener penetrates through the first connection holes and the second connection holes to connect the first support plate to the pull rod.

9. The cart according to claim 1, further comprising a pull rod assembly connected to the base plate assembly, wherein the pull rod assembly comprises a pull rod connected to the base plate and a holder detachably connected to the pull rod.

10. The cart according to claim 1, wherein the first support plate is connected to the base plate through at least two storage boxes.

11. The cart according to claim 1, further comprising a second connection assembly, wherein the storage box is mounted onto the base plate through the second connection assembly.

12. The cart according to claim 11, wherein the first support plate is mounted onto the storage box through the second connection assembly.

13. The cart according to claim 1, further comprising a second connection assembly, wherein the first support plate is connected to the base plate through the second connection assembly.

14. The cart according to claim 1, further comprising an external hanger, wherein the external hanger comprises a mounting portion and a connection portion, the mounting portion is detachably connected to an item, and the connection portion is mounted onto at least one of the cart or the storage box.

15. The cart according to claim 14, further comprising an external hanger assembly comprising the external hanger and an intermediate piece, wherein the external hanger is mounted onto a connection section of at least one of the storage box or the first support plate through the intermediate piece.

16. The cart according to claim 14, further comprising an external hanger assembly comprising fasteners, wherein the fasteners penetrate through the connection portion to mount the external hanger onto the first support plate.

17. The cart according to claim 14, wherein the item is attractable to the external hanger.

18. The cart according to claim 14, wherein the external hanger is mounted to an outer perimeter of the first support plate.

19. A cart applicable to a storage box, comprising:
a wheel assembly comprising rotatable wheels;
a base plate assembly comprising a base plate, wherein the base plate is connected to the wheel assembly, and the base plate assembly is at least partially disposed on an upper side of the wheel assembly; and
a first support plate, wherein the storage box is detachably connected to the base plate, the first support plate is detachably connected to the base plate through the storage box, and a space for storing items is formed on an upper side of the first support plate.

20. A cart applicable to a storage box, comprising:
a wheel assembly comprising rotatable wheels;
a base plate assembly comprising a base plate, wherein the base plate is connected to the wheel assembly, and the base plate assembly is at least partially disposed on an upper side of the wheel assembly; and
a first support plate connected to the base plate through at least one storage box, wherein the storage box is formed with an opening that is closable.
